(19) United States
(12) Patent Application Publication
(10) Pub. No.: US 2016/0239612 A1
(43) Pub. Date: Aug. 18, 2016

(54) HOME HEALTH CARE SYSTEM AND METHOD

(71) Applicant: Centria Healthcare LLC, Novi, MI (US)

(72) Inventors: Scott Barry, Novi, MI (US); Elliot Chocron, Novi, MI (US)

(21) Appl. No.: 14/937,519

(22) Filed: Nov. 10, 2015

Related U.S. Application Data
(60) Provisional application No. 62/077,689, filed on Nov. 10, 2014.

(51) Int. Cl. G06F 19/00

(52) U.S. Cl. CPC G06F 19/327; G06F 19/3481; G06F 19/3406

(57) ABSTRACT

A system and method for managing and tracking home health care workers is provided. A graphical user interface (GUI) implanted on a network of computing devices is provided for a management and performance platform. The platform provides utility for scheduling and monitoring tasks to be performed by a caregiver during a shift or visit to a remote location such as a client's home. The tasks performed by a caregiver are based on a plan that a clinical nurse or other supervising medical personnel establishes ahead of time prior to the caregiver visit. As caregivers log in on their remote device, a timestamp is captured and recorded that reflects the “Clock in” time for a time sheet record. As tasks are completed (or attempted), additional timestamps are captured and recorded. Documentation is generated from the captured information and used for timesheets, payroll, insurance billing, and medical record keeping.

### CROSS-REFERENCE TO RELATED APPLICATIONS

This application is a non-provisional application that claims priority benefit of U.S. Provisional Application Ser. No. 62/077,689, filed Nov. 10, 2014 the contents of which are hereby incorporated by reference.

### FIELD OF THE INVENTION

The present invention in general relates to patient care and in particular to a system and method for a management and performance platform for home caregivers.

### BACKGROUND OF THE INVENTION

Home health care is a wide range of health care services that are provided in a patient's home for an illness or injury. Home health care is usually more convenient, less expensive, and just as effective as care that would be obtained in a hospital or skilled nursing facility (SNIFF). Home health care covers a wide range of services and can often delay the need for long-term nursing home care.

Home health care may include occupational and physical therapy, speech therapy, behavior therapy, and skilled nursing. Examples of tasks provided by home health care may include wound care for pressure sores or a surgical wound, intravenous or nutrition therapy, injections, and monitoring serious illness and unstable health status. Home health care may also involve helping the patients with activities of daily living such as bathing, dressing, eating, housekeeping jobs, and monitoring a daily regimen of prescription and over-the-counter medications. The people who provide home health care are often licensed practical nurses, therapists, or home health aides (HAH). Most home health care providers work for home health agencies, hospitals, or public health departments that are licensed by the state.

The amount of record keeping and information required to properly care for a patient can be extensive, and the accuracy and the timeliness of the information is critical for the health and well-being of the patient. However, the remote locations of patients can make the process of information transfer difficult, especially with the amount of documentation required that has to be constantly updated. Thus, while there are many advantages to home health care there exists a need for improved systems and methods for managing information flow between home health care workers in the field and the health care agency office.

### SUMMARY OF THE INVENTION

An automated method for assigning tasks and monitoring the performance of tasks by a home health caregiver is provided, the method includes providing a graphical user interface (GUI) on a remote computing device assigned to a patient location. A care plan is sent with a set of tasks to the remote computing device, the set of tasks to be performed by the caregiver for the patient during a defined period of time. An opening time stamp is received in response to the caregiver logging on to the remote computing device. The caregiver performs an individual task from the set of tasks on the patient. Additional time stamps are received as individual tasks from the set of tasks are performed and logged on the remote computing device. An assessment of the patient's condition is received in response to the caregiver inputting the assessment into the remote computing device. A closing time stamp is received in response to the caregiver logging off the remote computing device. At least the opening time stamp, the additional time stamps, and the closing time stamp are communicated to the central computer. A caregiver modifies the care to a patient based on a set of tasks given in a time period following the closing time stamp and based on the data communicated to the central computer.

A system for assigning tasks and monitoring the performance of tasks by a home health caregiver is provided that includes: a server connected via a network to a central computer. One or more remote computing devices are located at patient locations. The central computer is in communication with the one or more remote computing devices. A memory system in electrical communication with the server contains a machine readable medium having stored thereon one or more sequences of instructions which, when executed by a processor, cause a method to be carried out, the method includes: providing a graphical user interface (GUI) to the remote computing devices. A care plan is sent with a set of tasks to the remote computing device from the central computer, the set of tasks to be performed by the caregiver for the patient during a defined period of time. An opening time stamp is received in response to the caregiver logging on to the remote computing device at the central computer. Additional time stamps are received as individual tasks from the set of tasks are performed and logged on the remote computing device. An assessment of the patient's condition in response to the caregiver inputting the assessment into the remote computing device is also received by the central computer. A closing time stamp is also received by the central computer in response to the caregiver logging off the remote computing device. At least the opening time stamp, the additional time stamps, and the closing time stamp are communicated to the central computer. A caregiver modifies the care to a patient based on a set of tasks given in a time period following the closing time stamp and based on the data communicated to the central computer.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a flow diagram of the high level process of using the inventive management and performance platform for home health care in accordance with embodiments of the invention;

FIG. 2 is a flow diagram of the execution of a care plan at a remote client/patient location in accordance with embodiments of the invention;

FIG. 3 is a flow diagram for performing task updates in accordance with embodiments of the invention;

FIGS. 4A, 4B, 4C, 4D, and 4E are a series of inter-related flow diagrams of the processes for carrying out certain embodiments of the invention;

FIGS. 4F, 4G, and 4H show a table outlining critical processes and activities for carrying out certain embodiments of the invention;

FIGS. 5A, 5B, 5C, 5D, 5E, 5F, 5G, 5H, 5I, 5J, 5K, 5L, 5M, 5N, 5O, 5P, 5Q, 5R, 5S, 5T, 5U, 5V, 5W, 5X, and 5Y are screen shots of a graphical user interface of the management and performance platform for home health caregivers on a remote portable computing device according to an embodiment of the invention;

FIGS. 6A, 6B, 6C, 6D, 6E, 6F, 6G, 6H, 6I, 6J, 6K, 6L, 6M, 6N, 6O, 6P, 6Q, 6R, and 6S are screen shots of a graphical user interface of the management and performance platform for home health caregivers on a personnel computer for use in the health care agency office in accordance to an embodiment of the invention; and

FIG. 7 is a schematic diagram illustrating an overall view of communication devices, computing devices, and mediums for implementing embodiments of the invention.

The detailed description explains the preferred embodiments of the invention.

### DETAILED DESCRIPTION OF THE PREFERRED EMBODIMENTS OF THE INVENTION

The present invention has utility as a system and method for managing and tracking home care workers. A graphical user interface (GUI) implanted on a network of computing devices is provided for a management and performance platform. Embodiments of the inventive management and performance platform provide utility for scheduling and monitoring tasks to be performed by a caregiver during a shift or visit to a remote location such as a patient's home or residential setting.

As used herein, a caregiver is defined to include registered nurses (RUNS), licensed practical nurses (LENS), physical therapists (PTS), occupational therapists (LOTS), speech therapist (SLAPS), medical assistants (MASS), certified nurse's aides (CNAs), home health aides (HHAs), Behavior technicians and Board Certified Behavioral Analysts (BLABS), familial caregivers, and patient care technicians/aides (PACTS/PICAS).

As used herein, a central computer is defined to be a computer that receives the inputs from at least one remote device, either directly of a network or via a server. In this context central does not imply geographic centrality of the computer relative to remote devices.

The tasks performed by a caregiver are based on a plan that a clinical nurse or other supervising medical personnel establishes ahead of time prior to the caregiver visit. As caregivers, also referred to as field staff, log in on their remote device, a timestamp is captured and recorded that reflects the “Clock in” time for a time sheet record. Furthermore, as tasks are completed (or attempted), additional timestamps are captured and recorded. In addition, while working in the field, caregivers may complete assessments or capture statistics on the patient, and at the end of a shift when the caregiver logs out the information is captured as a “Clock out” for the timesheets record along with the employee and client signatures. Documentation is generated from the captured information and used for applications illustratively including timesheets, payroll, insurance billing, and medical record keeping. In an embodiment an on line archive of data for insurance purposes is maintained. In still another embodiment, patient care plan is modified based on the caregiver inputs that are received by the central computer, with or without supervisory medical personnel input.

Additional activities provided by the software of the inventive management and performance platform in specific embodiments illustratively include one or more of: the real time monitoring for overdue tasks, supply updates, deferred priority tasks, time sheets, incident reports, and in some cases inactivity at a client site. All of the monitoring results may be communicated to the home office during a shift so that office staff may follow up with the caregiver to ensure that the care plan is applied correctly, consistently and in a timely manner.

Embodiments of the invention may apply a rules engine program for converting tasks into a daily shift schedule, where the tasks are rules and the program interprets the rules in the context of the specific day, shift time and user role. Inputs from previous shifts are used in some embodiments to modify the care plan for a subsequent shift of patient care.

Computing devices used in inventive embodiments of the home care management and performance platform include remote devices in the form of portable computing devices including tablets and mobile communication devices. In a specific embodiment, a dedicated tablet such as an pad™ manufactured by Apple Computer, Inc. Serves as the data entry and monitoring device for each specific patient at a time. The remote devices are dedicated to a certain location for the specific service of a client, also synonymously termed a patient throughout, at the location. In a specific embodiment, multiple patient clients are served using the same remote device at that location. In a home healthcare setting, the device is locked and thereby devoted to a single patient and a single care plan. The configuration of the remote device and applications available on the remote device are restricted, and may only be changed by an administrator. The administrator may remotely clear or wipe data from the remote device, as well as load or restrict apes. Locating features on the remote device such as global positioning satellite (GPS) or an Internet protocol (TIP) address allow for the identification of a client location as the device is intended to be retaining at the patient locale. The use of remote devices in embodiments of the invention allow for paper less record keeping and client interaction, while simplifying documentation of shift activity. The use of remote devices further provides in certain embodiments for improved communication, data security, timesheets and payroll processes. Users must login to view data on the remote devices, and data sent and received by the remote devices is encrypted. Care plan adjustments are enabled by the present invention in a way that have not previously been available.

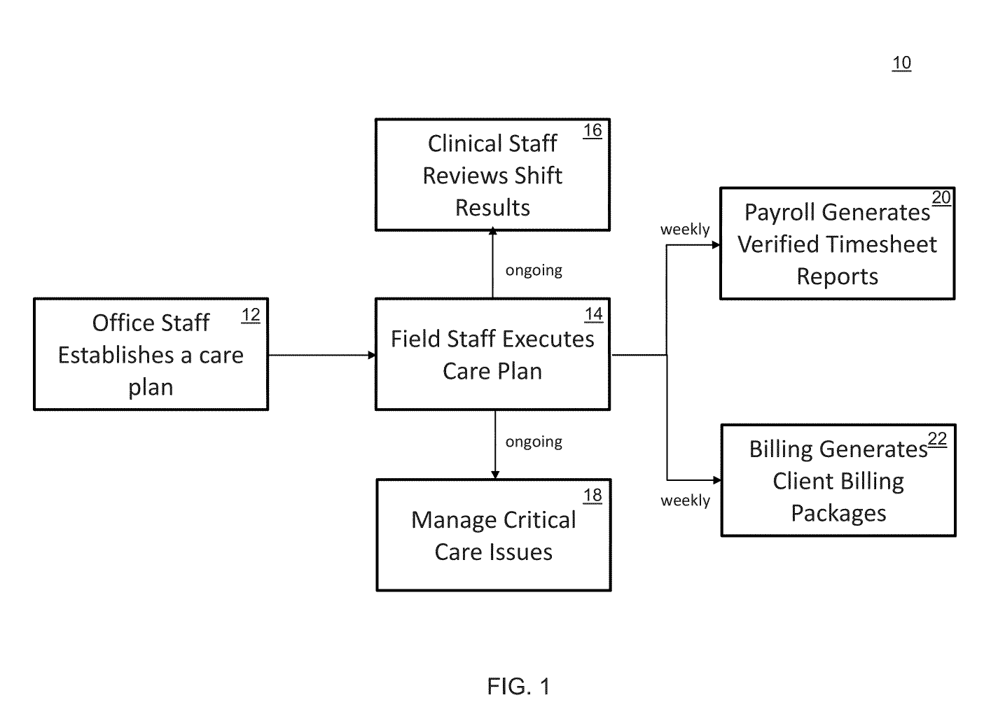

Referring now to the figures, FIG. 1 is a flow diagram of the high level process 10 of using the inventive management and performance platform for home health care. Health care personnel (clinical staff) in the central office of a home health care agency devise a care plan for a client/patient at step 12. The care plan with specific tasks is sent to a portable computing device at a client location for field staff (caregiver) execution of the care plan at step 14. The clinical staff reviews the work of field staff personnel during or after the shift in step 16, and manages any critical issues that may have arisen during the shift at step 18 on an ongoing basis which may also be in real-time. In some embodiments, task activity and timesheets/billing hours are automatically reported to the accounting department for the generation of verified timesheets on a daily or weekly basis at step 20, as well as for client billing and insurance claims at step 22.

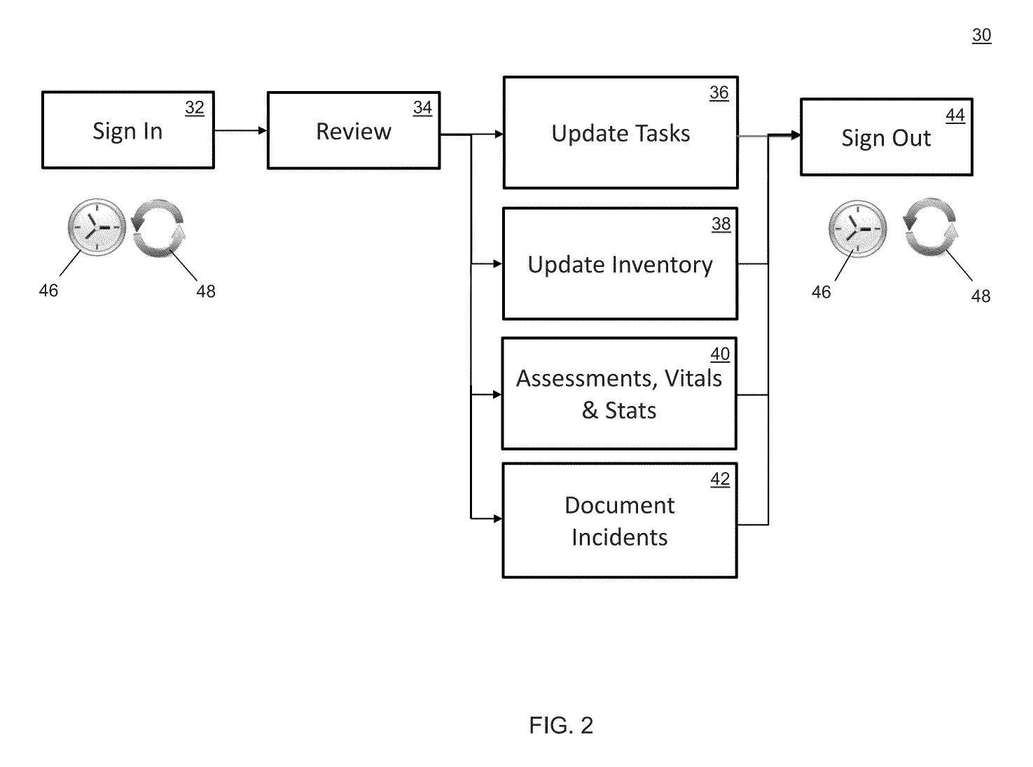

FIG. 2 is a flow diagram of the execution of a care plan 30 at a remote client/patient location. The caregiver signs on at step 32 to their portable computing device and a time stamp is automatically generated (icon 46) to mark the beginning of their shift. The device is synced (icon 48) upon login. During the syncing process the remote device will exchange information with the server to gather any changes made by the clinical or office staff that may impact the caregiver's shift, and to provide proper care to the patient. During sign on, the application checks to see if the caregiver has an open timesheets. If there is an open timesheets, the caregiver will be notified to use that timesheets. In some inventive embodiments, when tasks are performed notifications are communicated but do not otherwise receive the completed task details until completion of the shift. If other users have open timesheets for the client, in some inventive embodiments, these timesheets will be automatically closed so that the caregiver can continue to sign in. If the caregiver does not have an open timesheets, one will be created. Upon sign on, the caregiver is automatically taken through several screens and asked to confirm that they have reviewed the information at step 34. These screens include a patient care plan, the previous shift for the patient (what tasks were performed and patient condition during the previous shift), and any notes about the patient. By way of example, a 48 hour log is maintained on the device for caregiver reference. A task will be created or each review step indicating that the caregiver has reviewed the steps during their shift. During the shift the caregiver updates the status of the assigned tasks at step 36. The supply inventory may be updated at step 38 for ordering additional supplies to replace what has been used, as well as in some inventive embodiments for generating billing or order sheets for used consumable supplies. The caregiver in some specific embodiments, inputs information about the patient status (assessment, vitals, statistics, or a combination thereof) into their device for reporting and record keeping at the home office at step 40. Any incidents, such as an injury to either the patient or caregiver, which may occur during the shift are documented at step 42. At the completion of the shift the caregiver signs out at step 44, and a time stamp is automatically generated (icon 46) to mark the end of their shift. The information on the device is also automatically synced (icon 48) with the home office using conventional software.

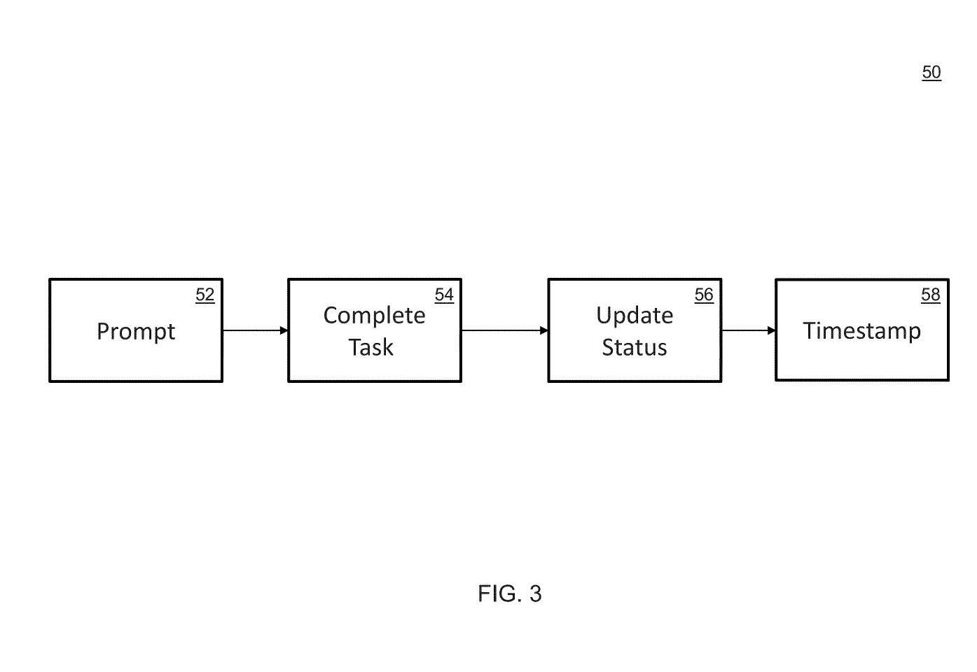

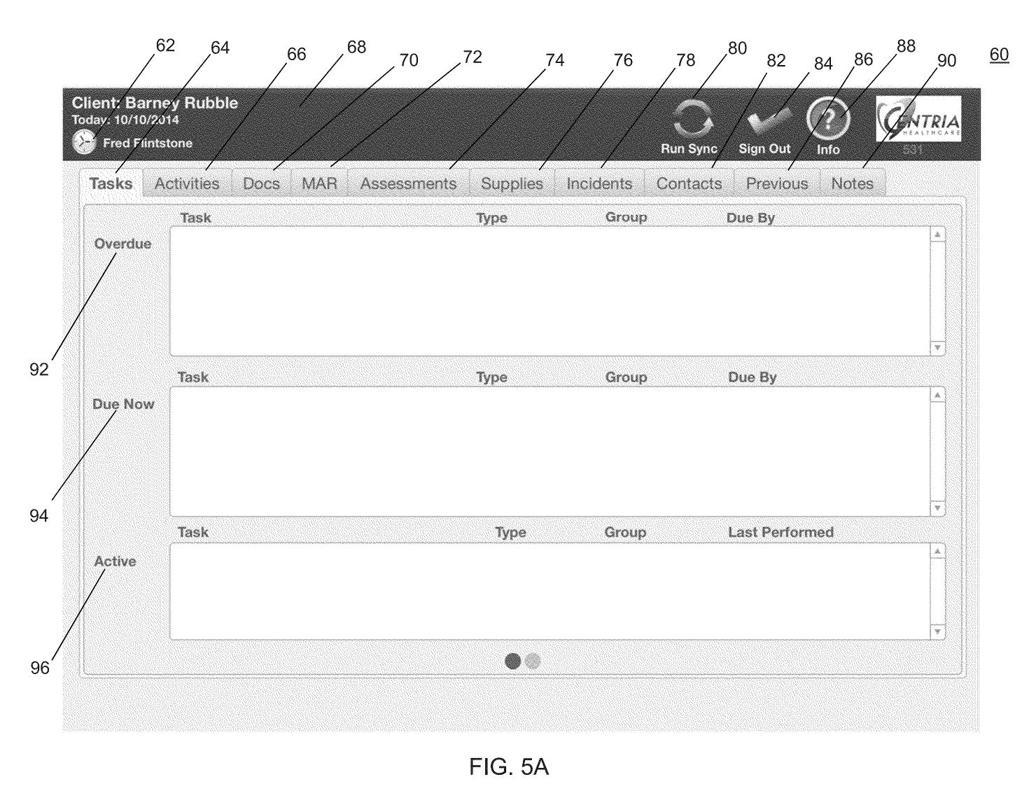

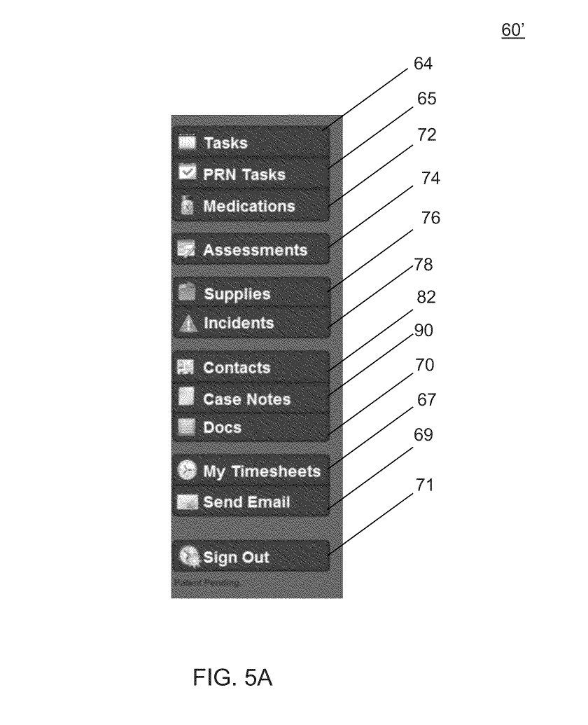

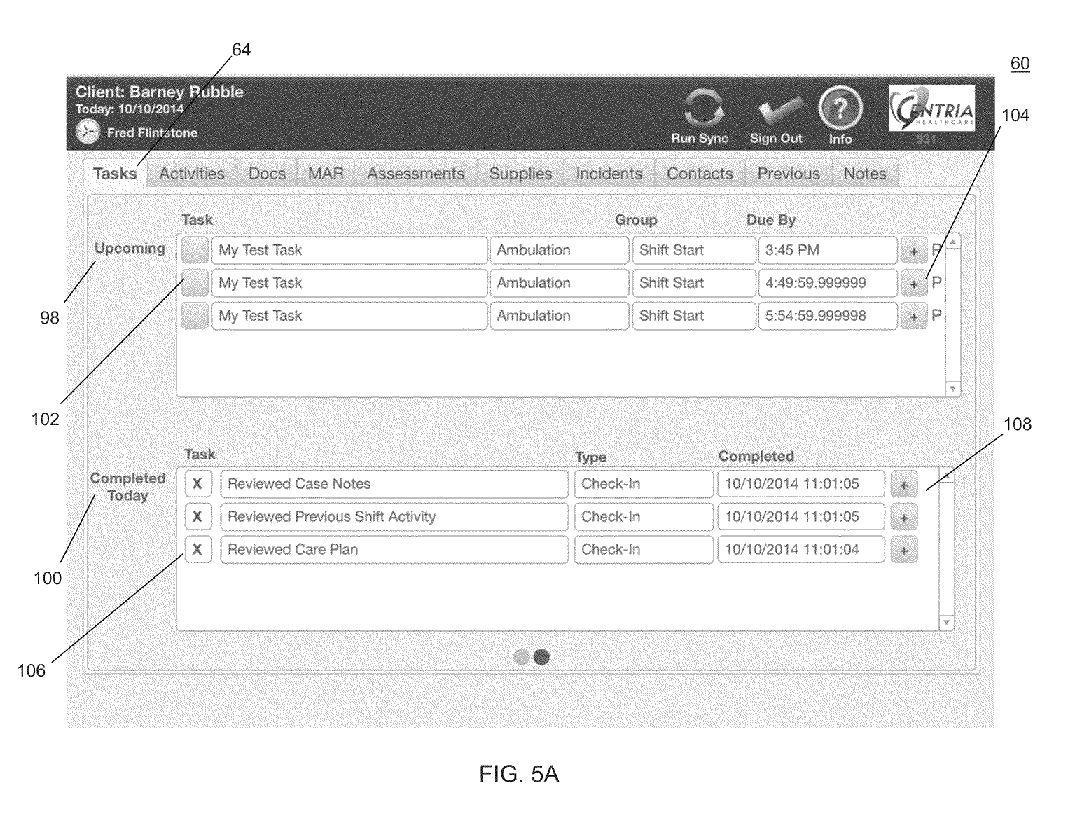

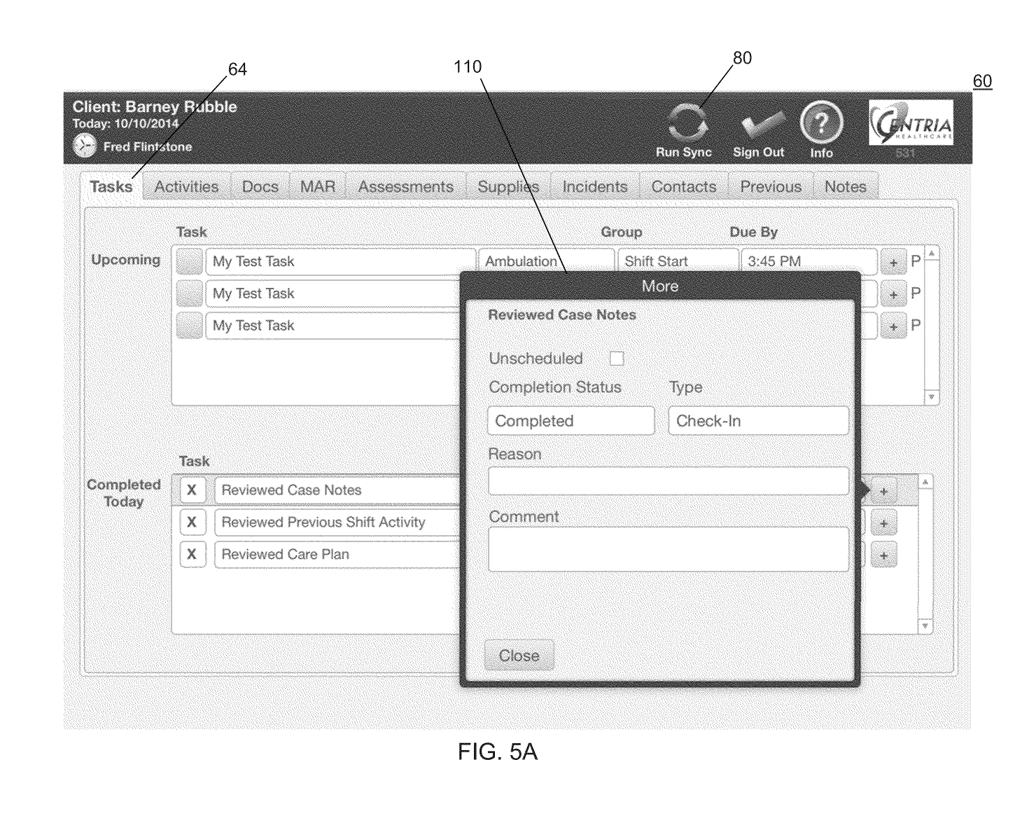

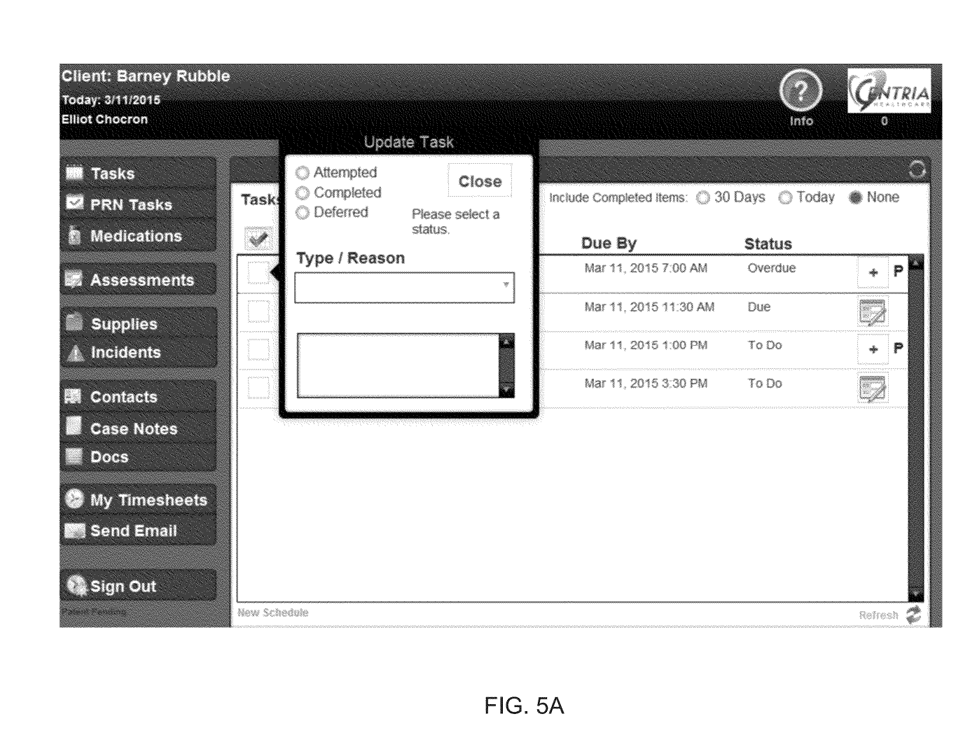

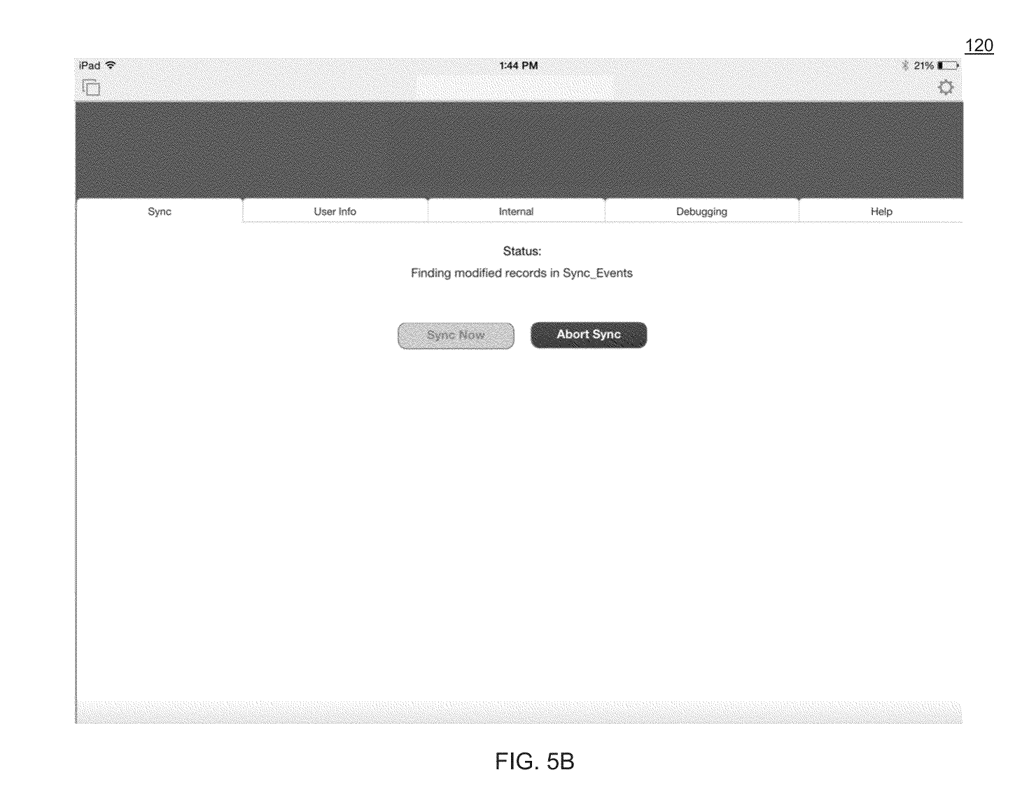

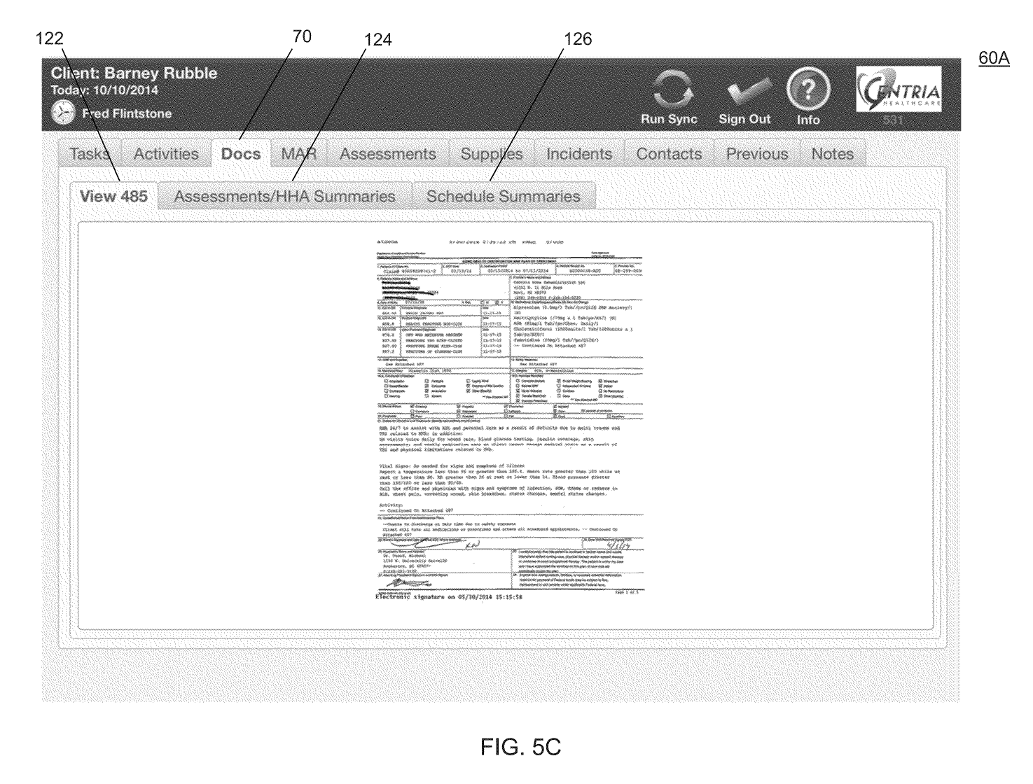

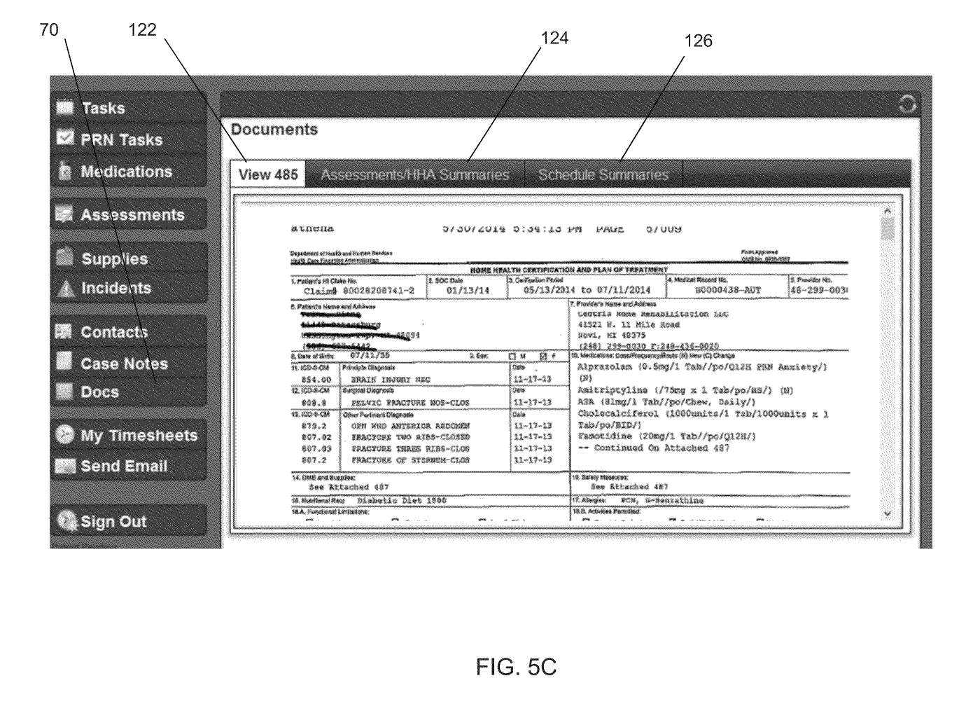

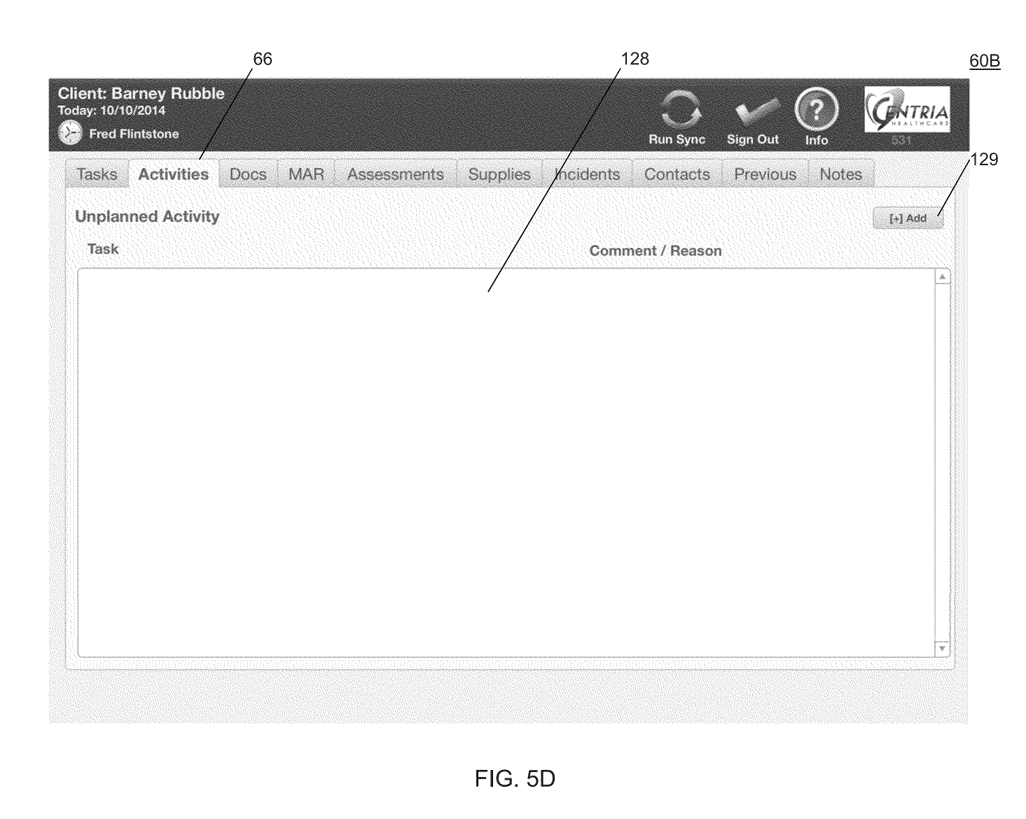

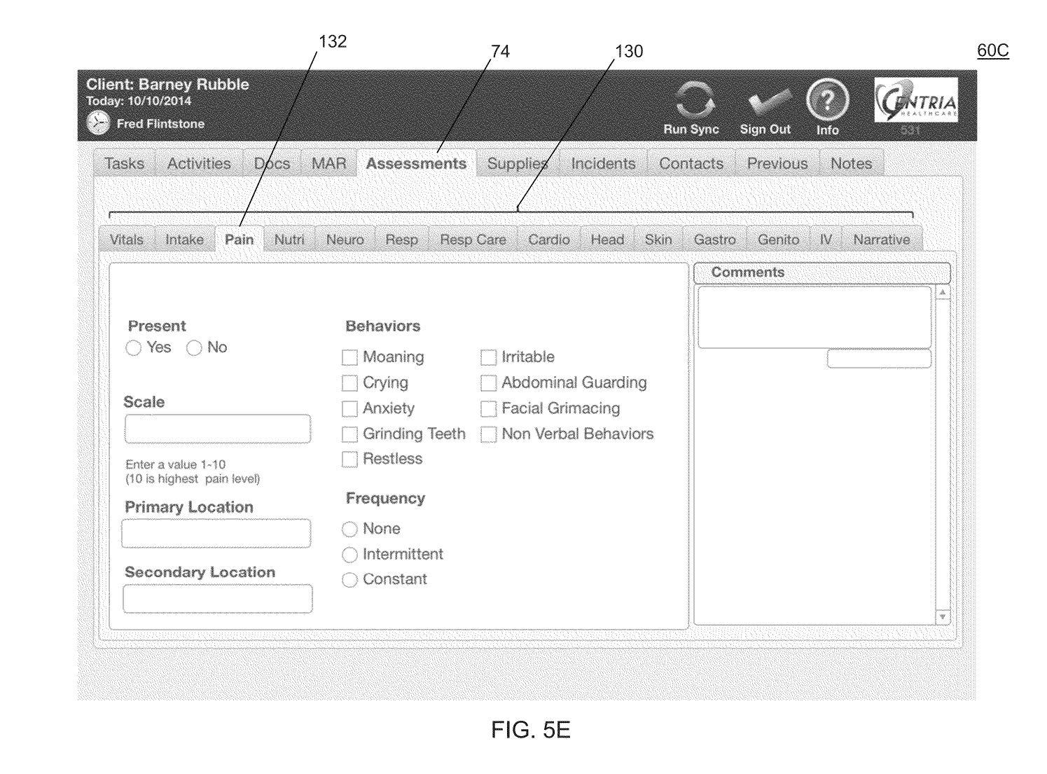

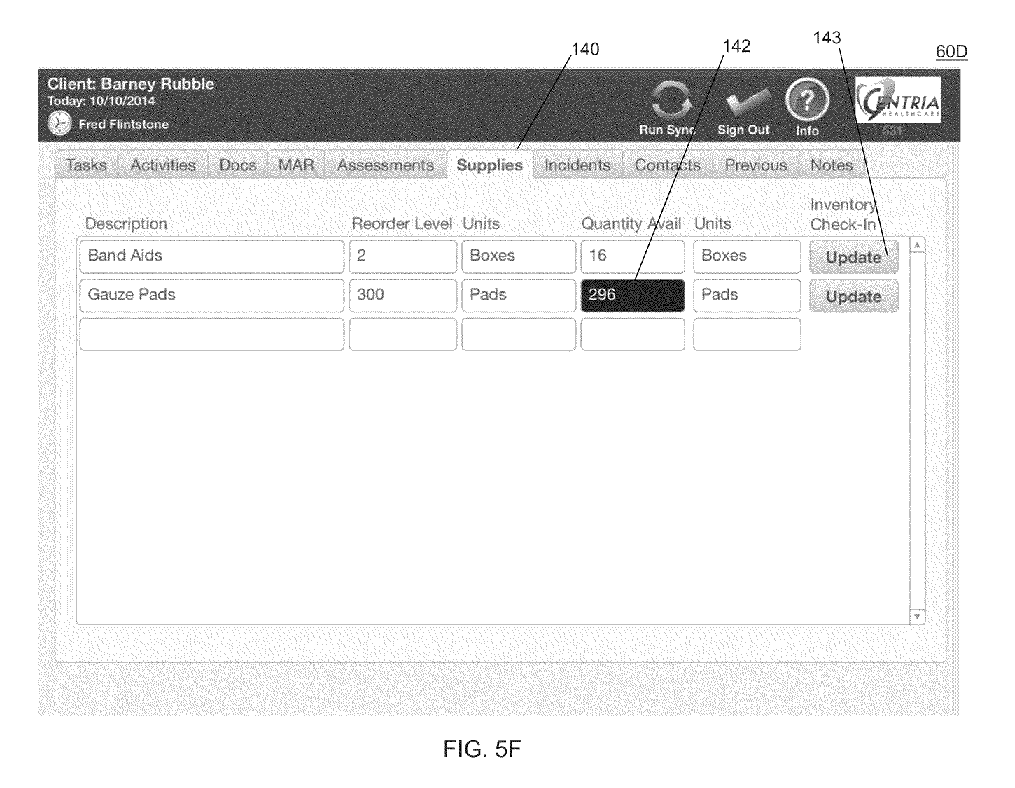

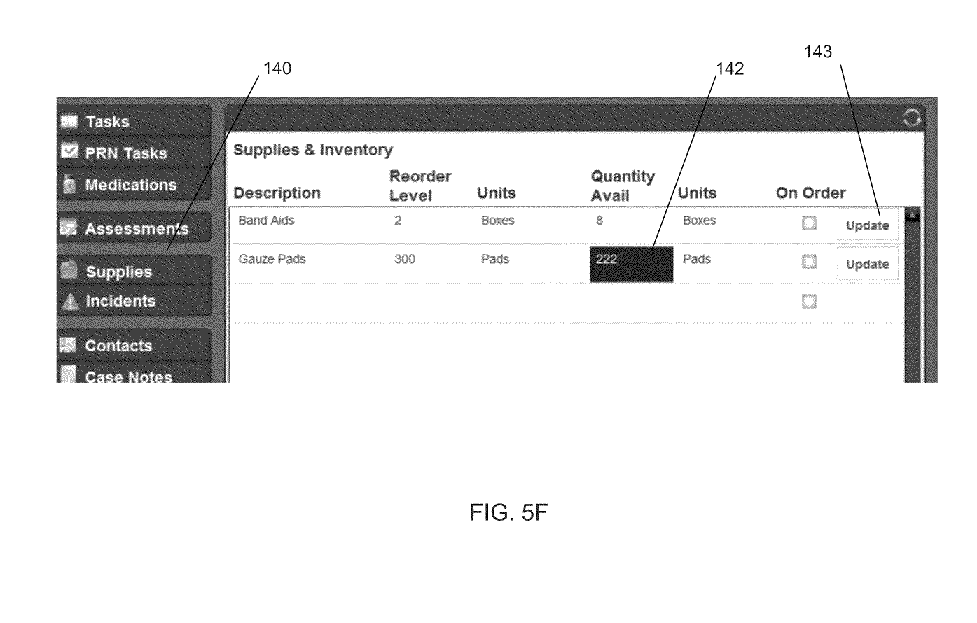

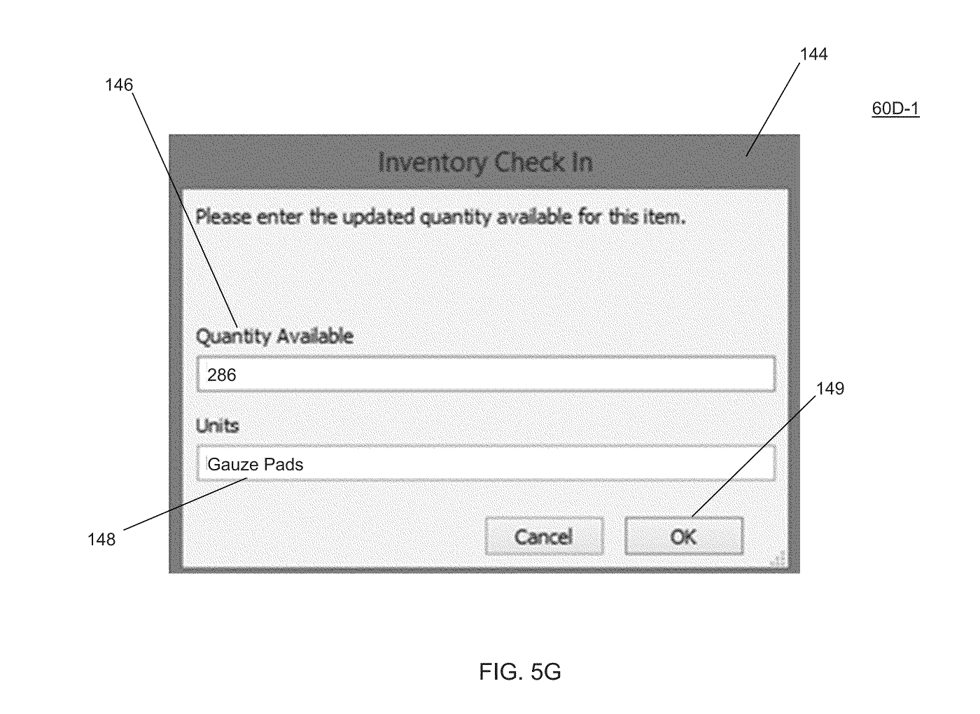

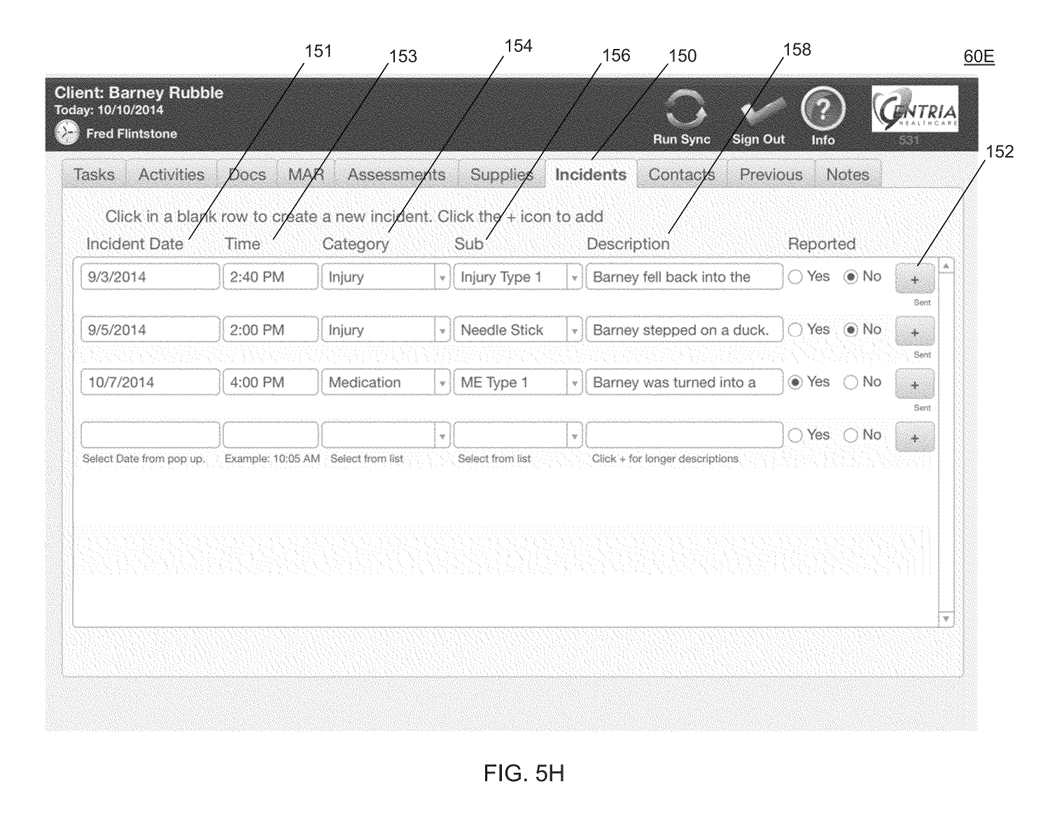

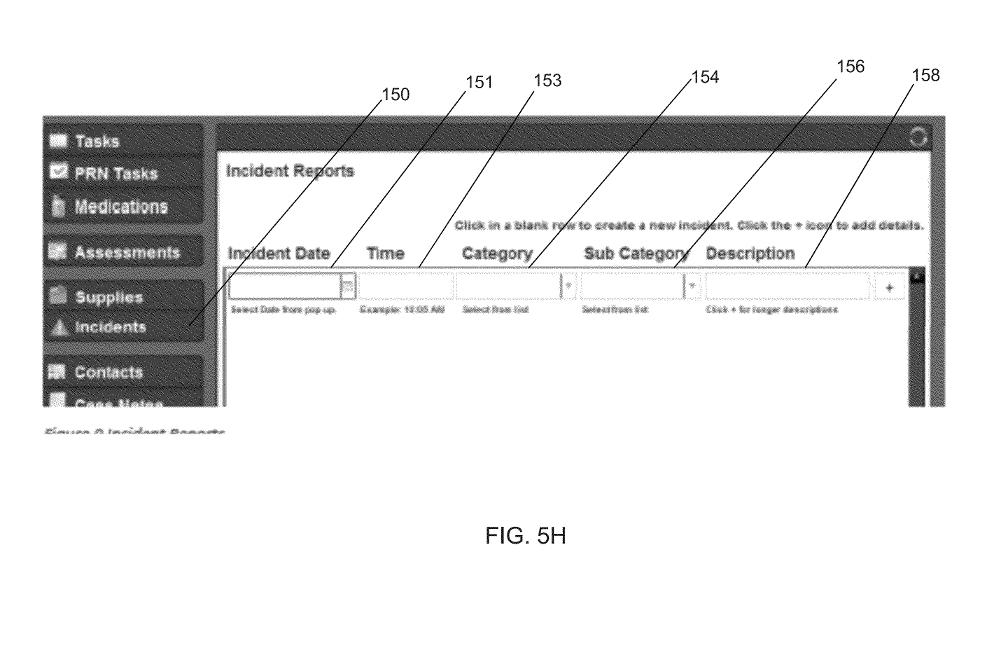

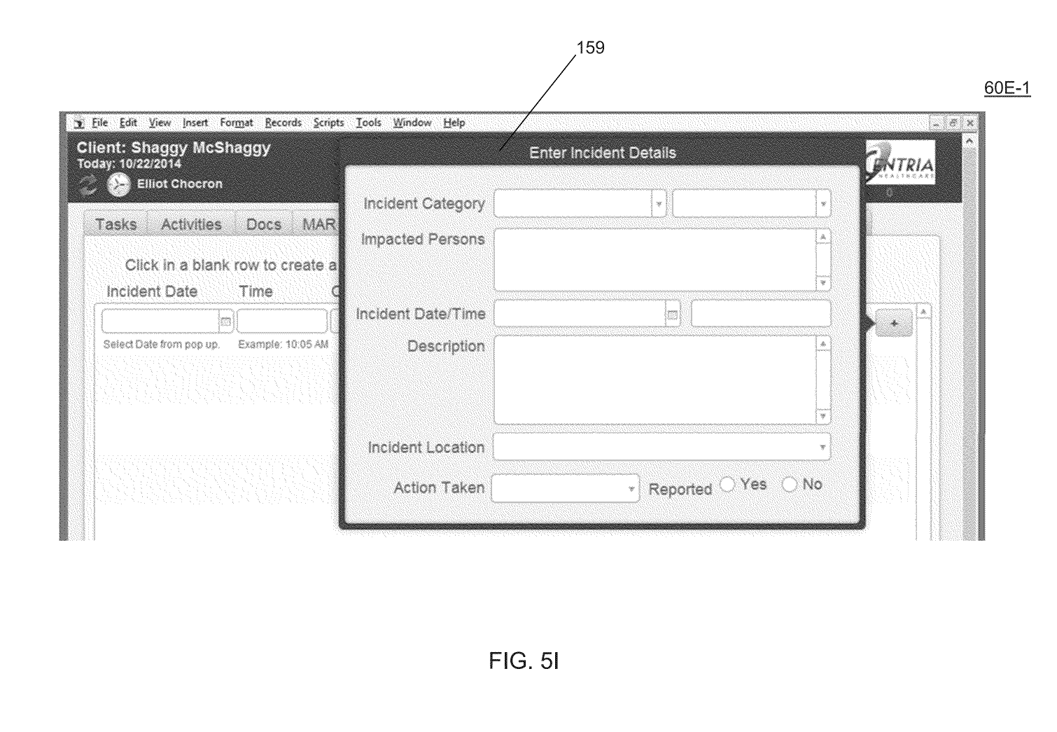

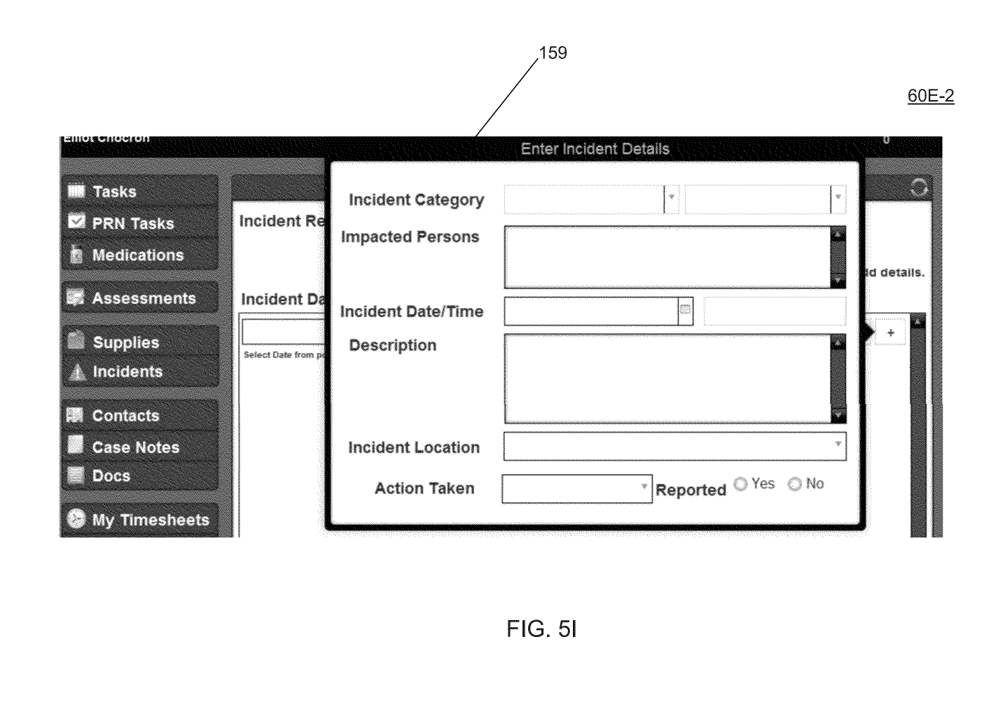

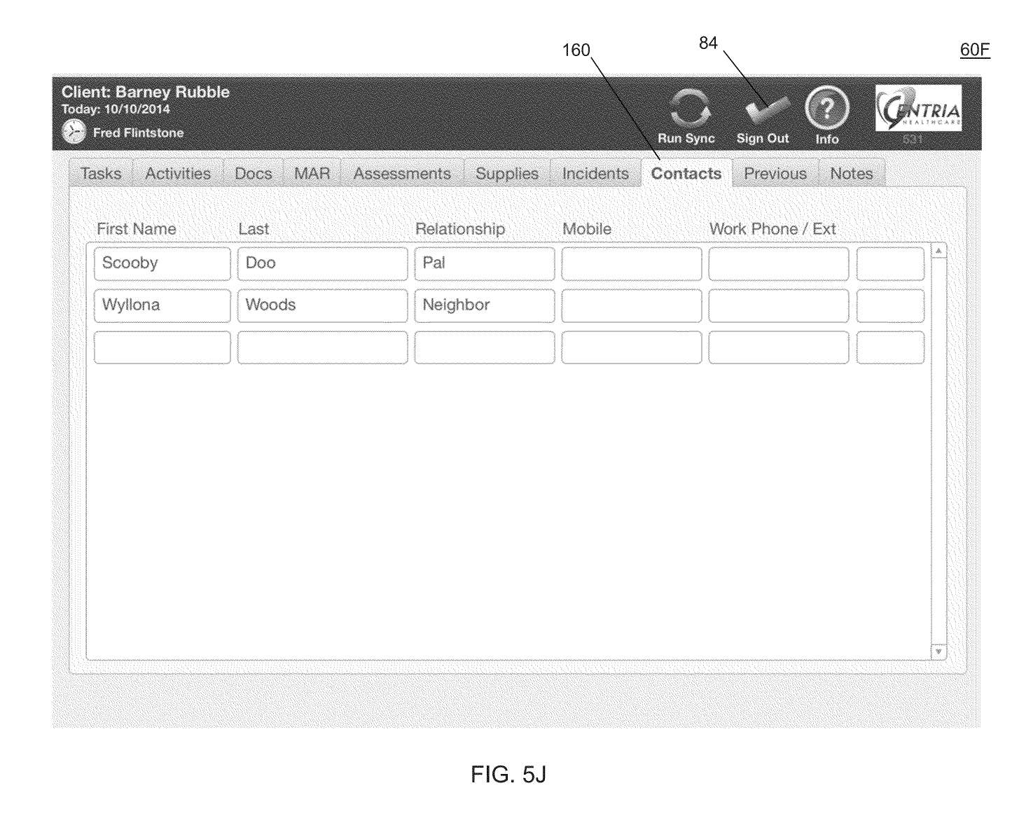

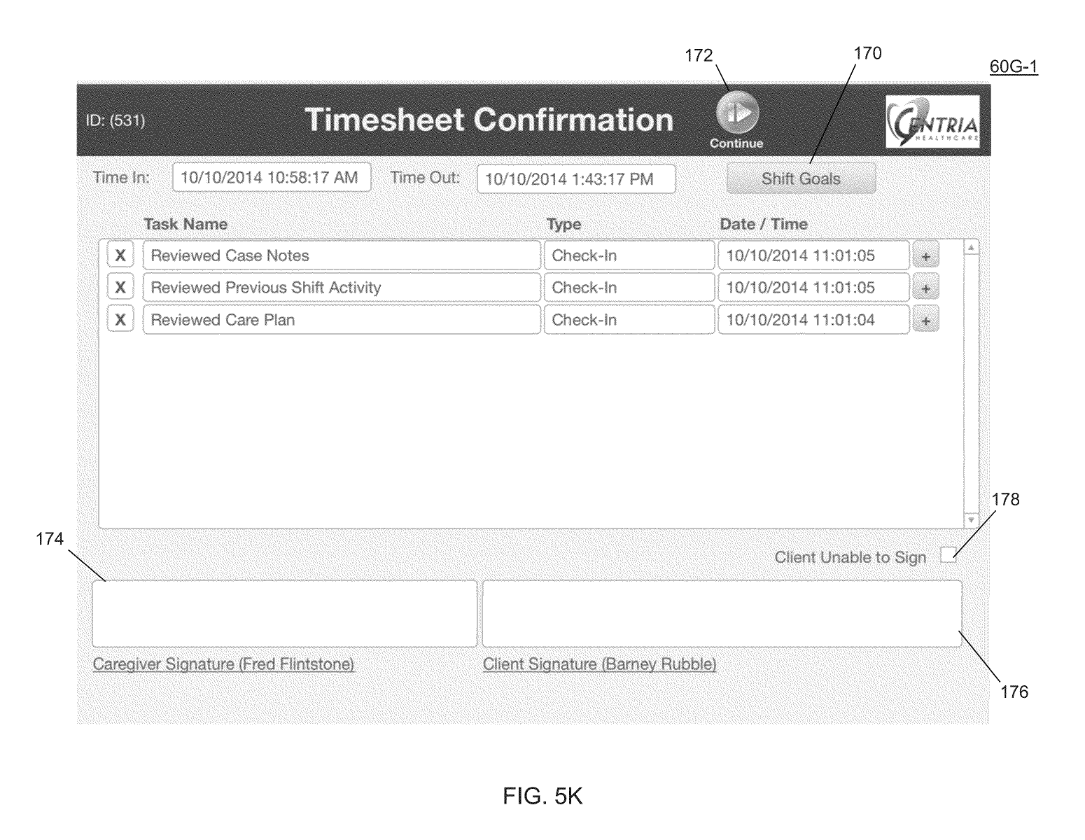

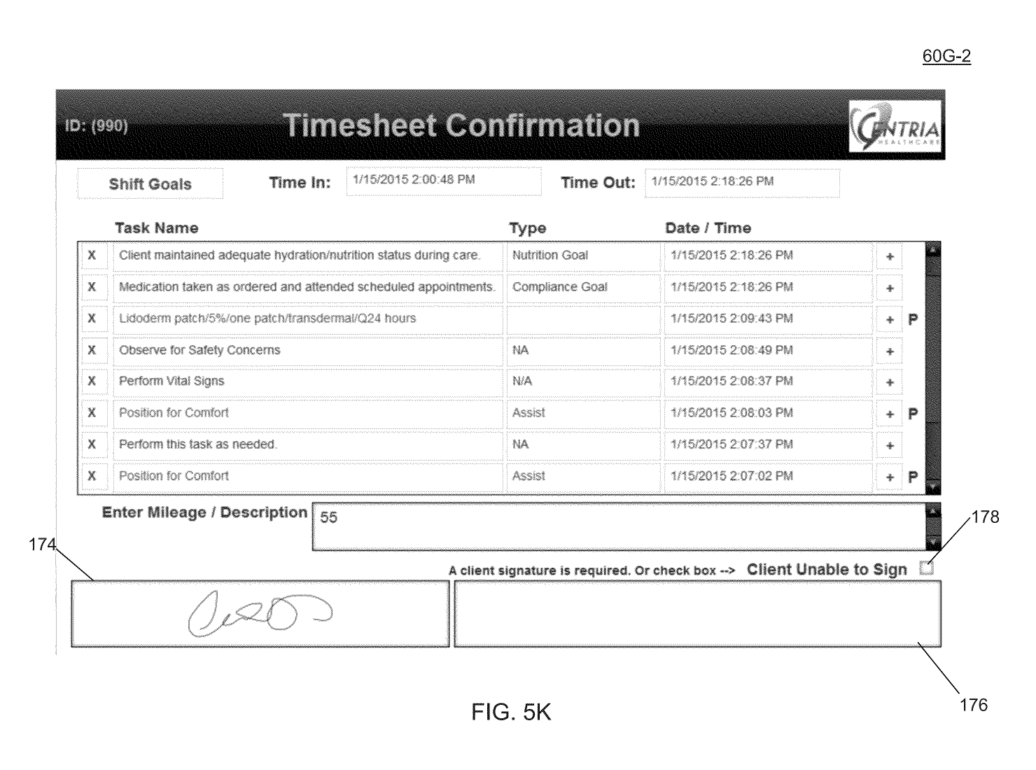

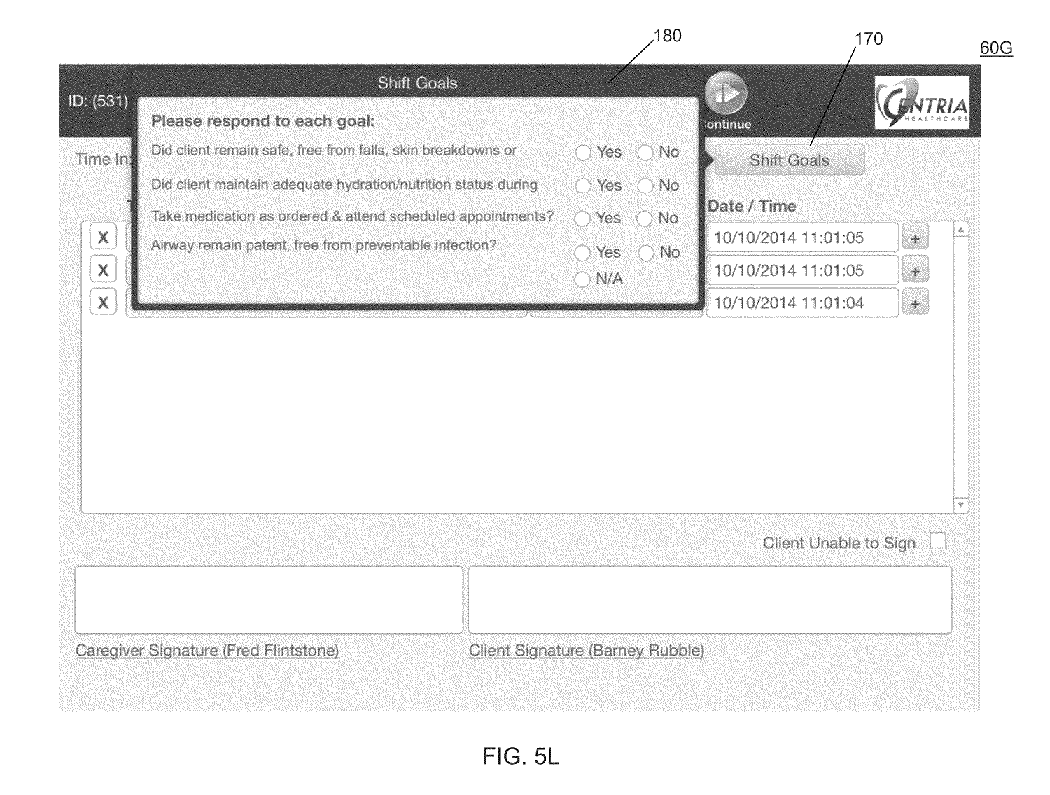

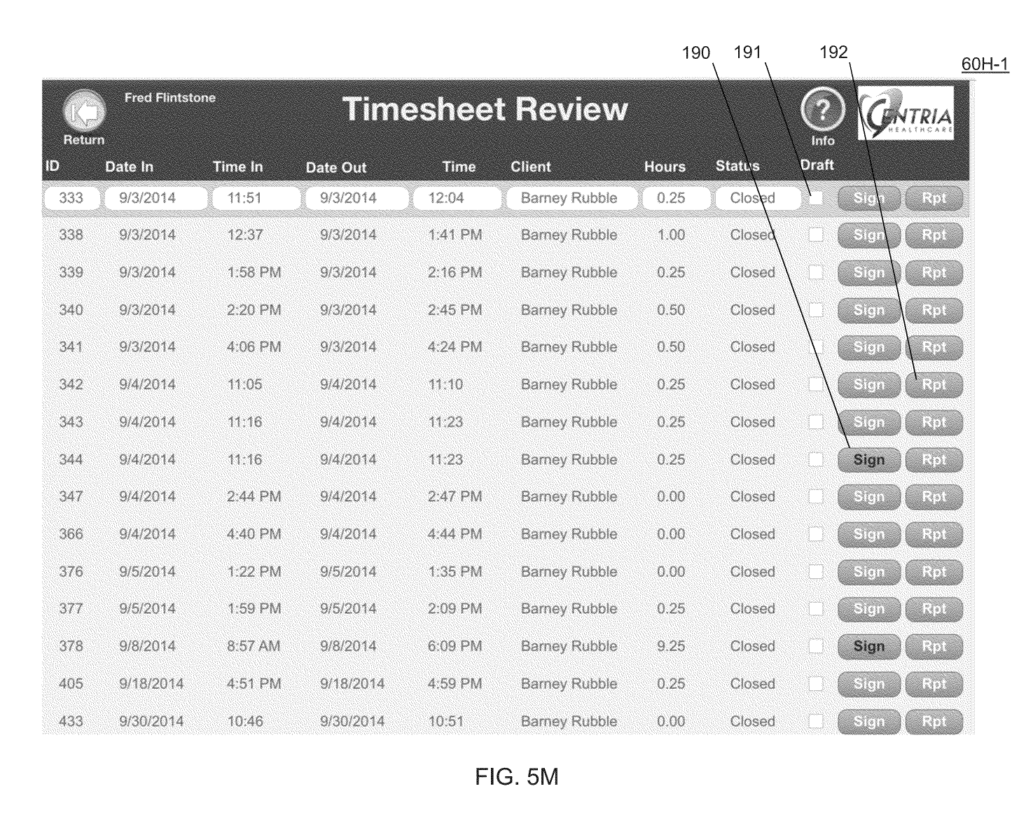

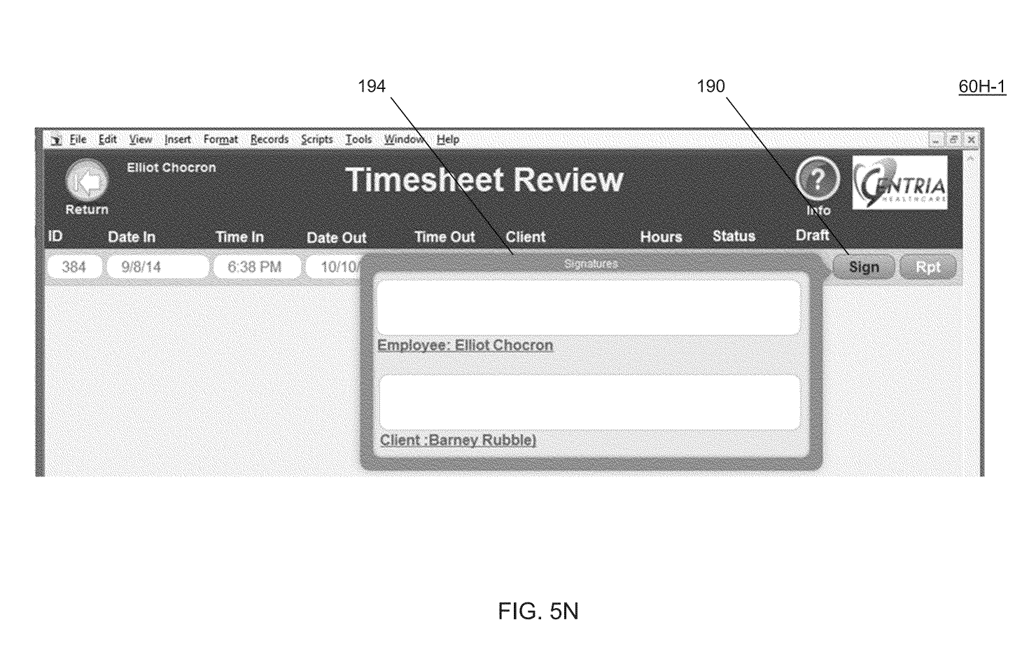

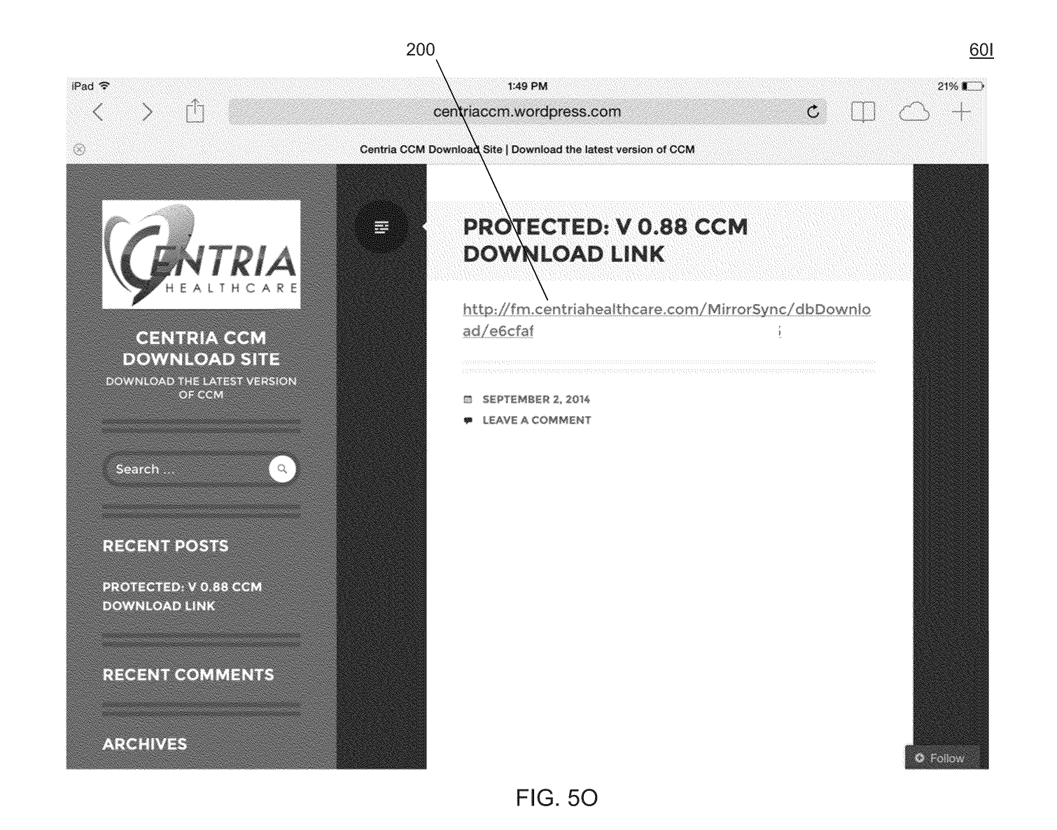

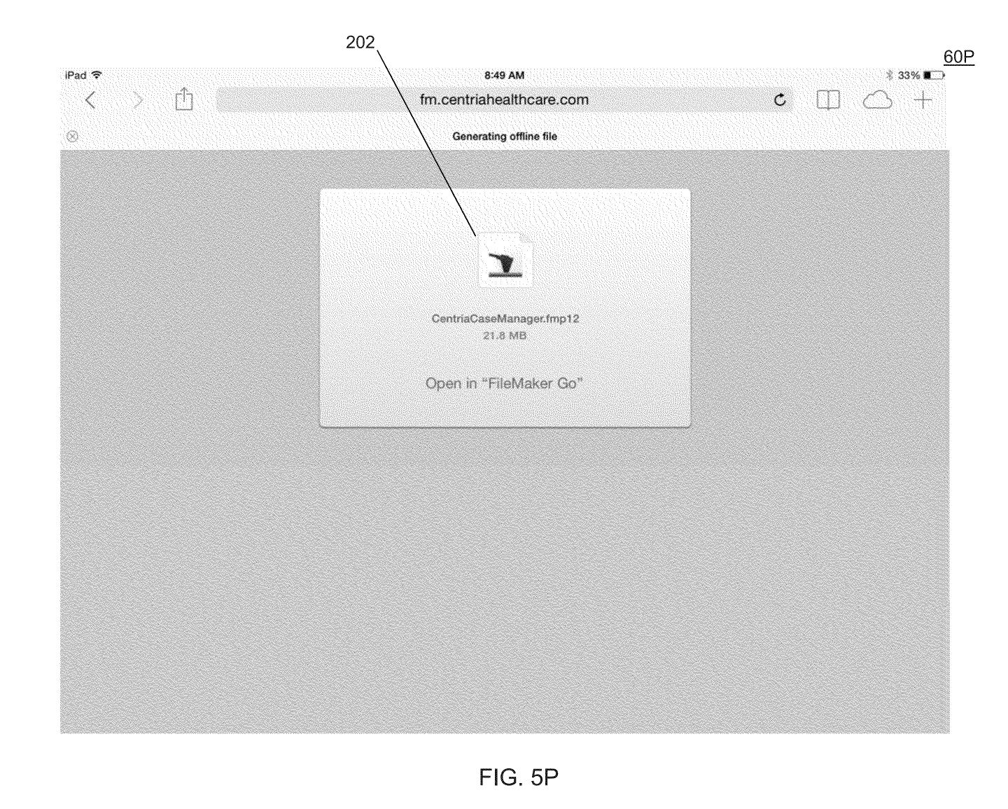

FIG. 3 is a flow diagram 50 for performing task updates at the client location in accordance with embodiments of the invention. Prompt 52 is based on alerts from the home office, and tasks moving from “upcoming” to “due now” and then to “overdue”, as will be discussed in greater detail with respect to FIGS. 5A, 5B, 5C, and 5D. In a specific embodiment, the prompts may be color coded. Complete task 54 represents the providing of care, performing assessments and taking vitals of the patient. The step of updating status 56 involves the caregiver to mark the status of a task as complete, attempted, or deferred. The step of save and update time 58 involves the caregivers portable computing device storing the completed task, capturing the timestamp, client name, or a combination thereof, and sending the information back to the home office server at shift end.

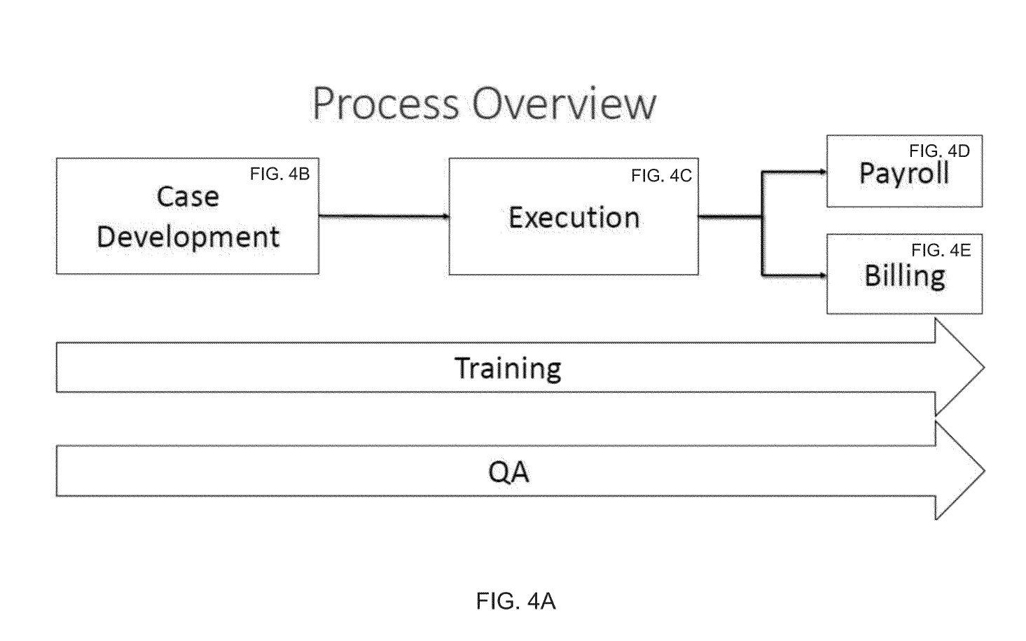

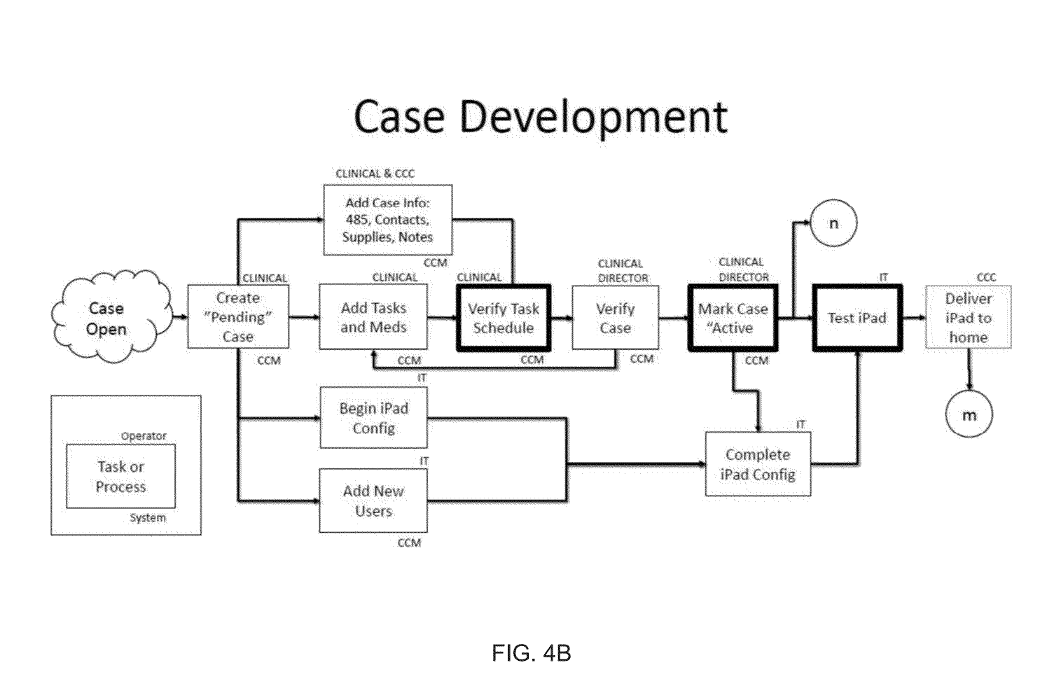

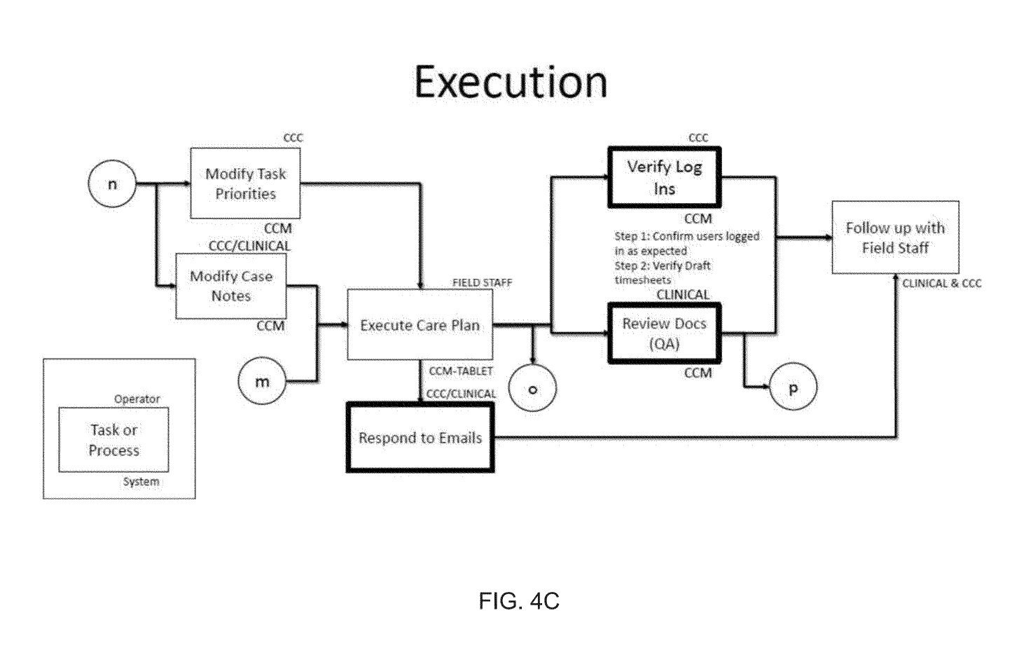

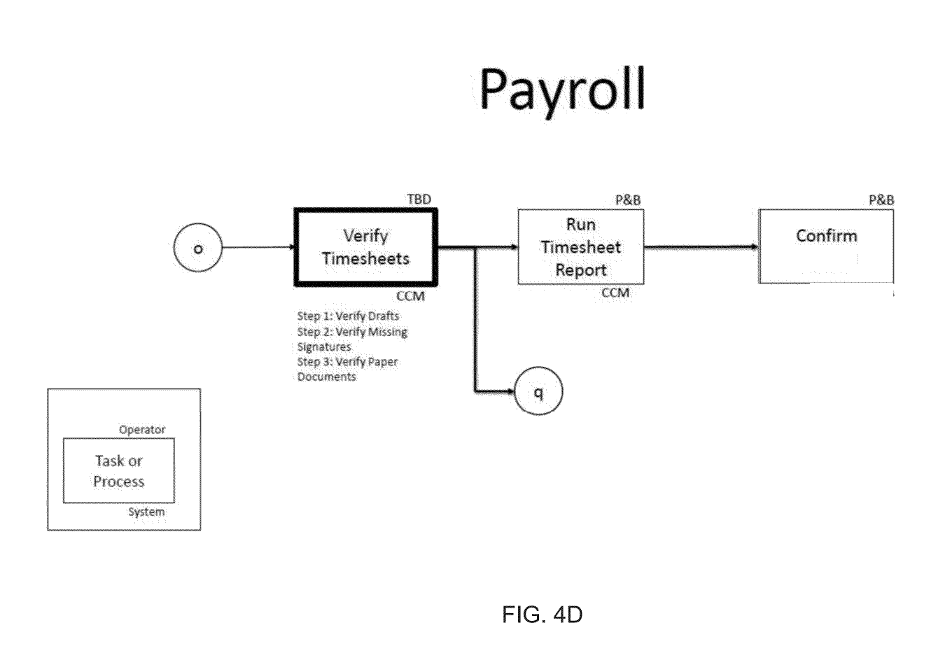

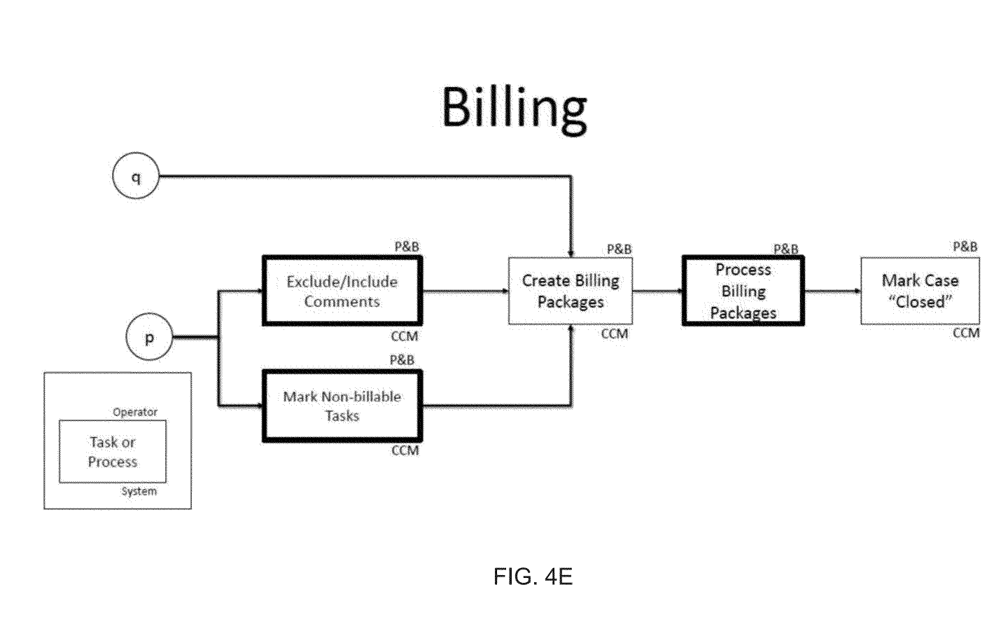

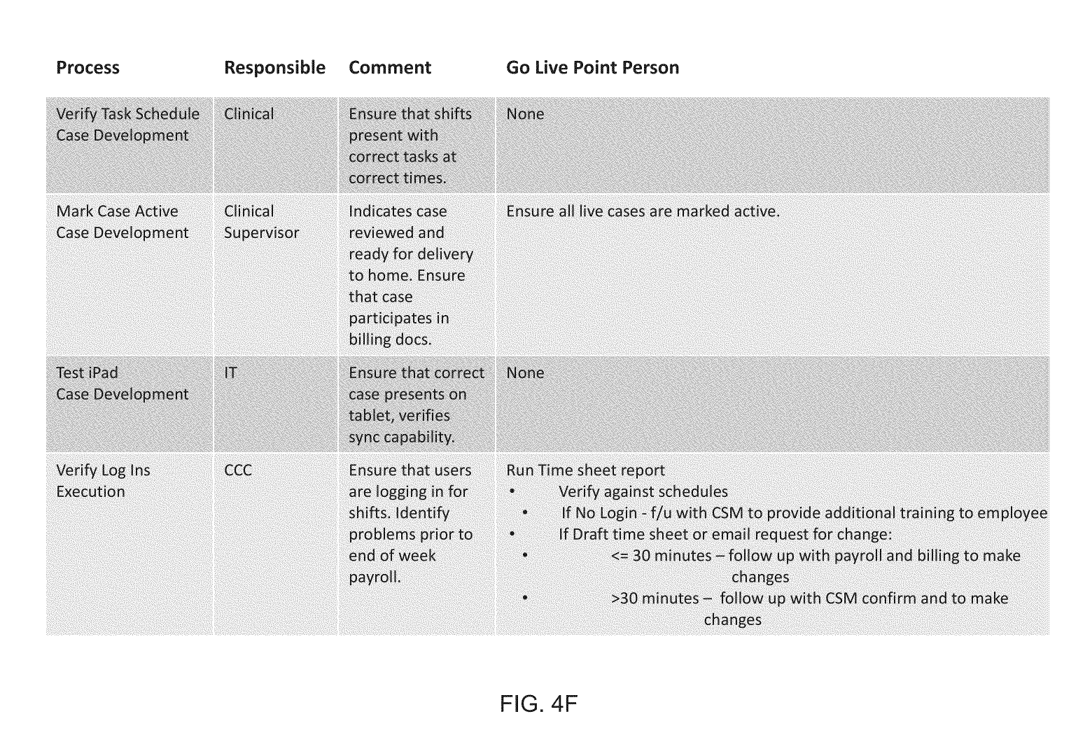

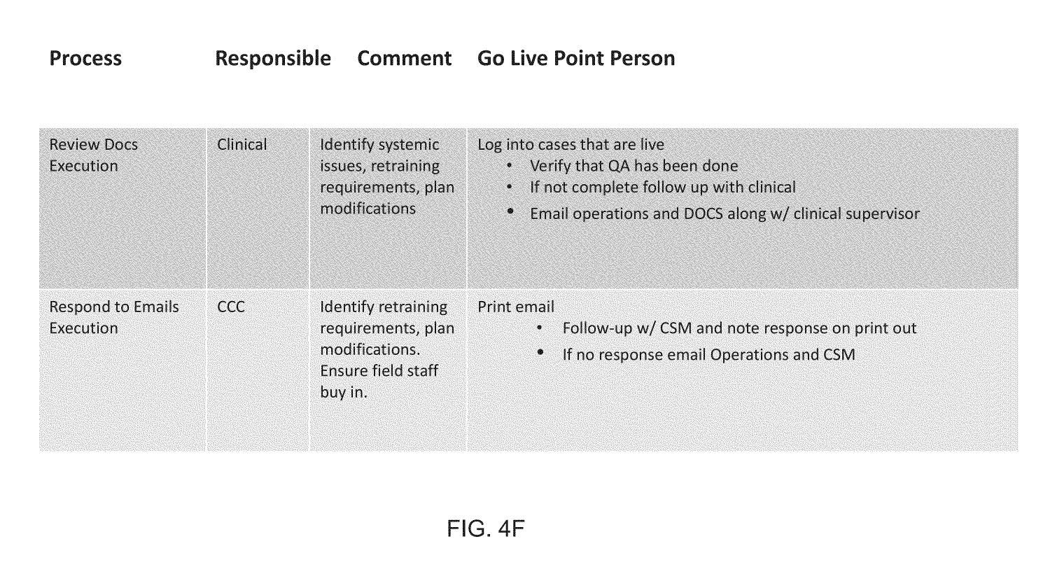

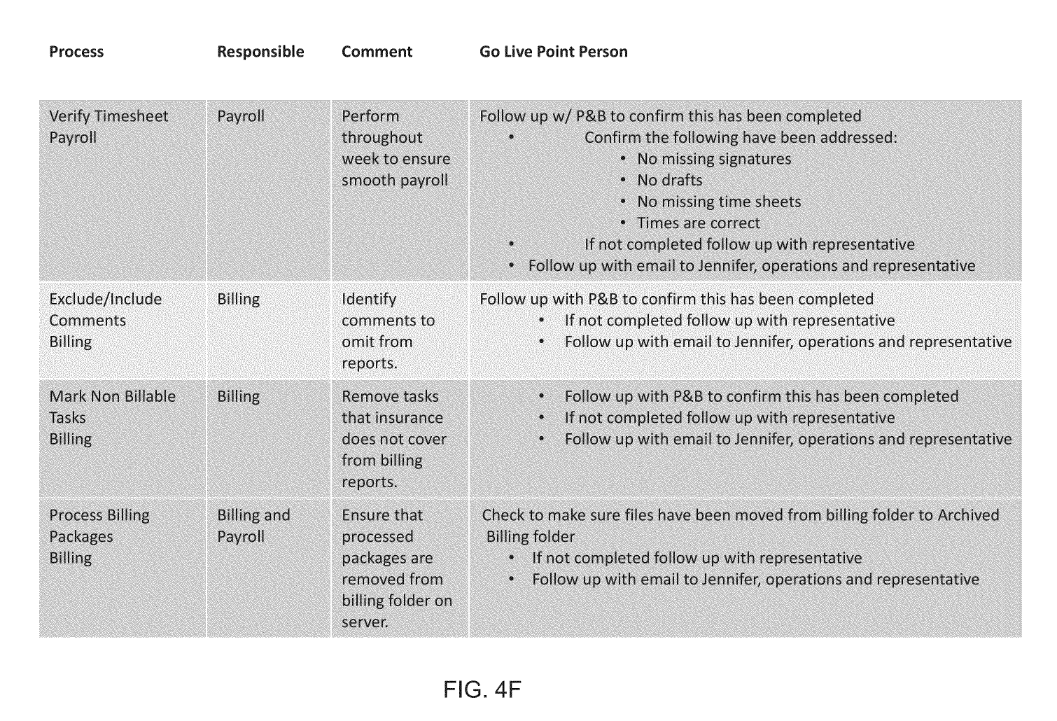

FIGS. 4A-4E are a series of inter related flow diagrams of the processes for carrying out specific embodiments of the present invention. FIG. 4A shows a process overview of the separate internal processes involved for support of embodiments of the management and performance platform for home health care. FIG. 4B illustrates the process flow for case development for a client/patient. FIG. 4C illustrates the process flow for execution of a client/patient case. FIG. 4D illustrates aspects of the payroll process. FIG. 4E illustrates aspects of the billing process. FIGS. 4F, 4G, and 4H show a table outlining critical processes and activities for carrying out embodiments of the invention.

FIGS. 5A, 5B, 5C, 5D, 5E, 5F, 5G, 5H, 5I, 5J, 5K, 5L, 5M, 5N, 5O, 5P, 5Q, 5R, 5S, 5T, 5U, 5V, 5W, 5X, and 5Y are a series of screen shots of the graphical user interface (GUI) of the management and performance platform for home health caregivers on a remote portable computing device according to an embodiment of the invention. The example shown is based on an AP designed for use on the pad™ manufactured by Apple Computer, Inc., however it should be noted that other portable computing devices and tablets may be used to implement embodiments of the invention.

FIGS. 5A, 5B, 5C, and 5D show the dashboard 60, which is the home or main screen of the inventive AP. The dashboard 60 has a title bar 68 which has the name of the client that is being treated as well as the current time and date of the shift. The dashboard 60 is organized into tabs. The caregiver taps on a tab to go to that section. One additional tab contemplated is to send an email to the client care coordinator (CC) that is synonymously referred to as a client service Manager (CSM) Some tabs are further organized into sub tabs or have multiple slides. An additional embodiment of the dashboard 60′ is organized into separate section that are chosen through the tabs shown in FIG. 5B. In the specific embodiments shown the tabs include:
Tasks (64)—Shows tasks that are due or completed during the caregiver shift.
PRN Tasks (65)—Shows (pro re nata—when necessary) tasks (excluding meds) that may be completed as needed tasks, and may also add unplanned tasks in this section.
Activities (66)—Use this tab to add unplanned tasks. It is appreciated that in some embodiments of the present invention, this tab is integrated into the Tasks tab.
My Timesheets (67)—Review timesheets for a specific client on the tablet, and user may update signatures for previous shifts.
Send Email (69)—Send a non-critical email to the CSM/CC or Clinical Lead. Email is one way—office staff cannot send return emails to the tablet.
Docs (70)—Use this tab to view relevant documents during a caregiver shift. The Docs tab 70 is organized into three sub-tabs.
   View 485—View the Care Plan for the client as shown in FIG. 5G and FIG. 5H. The user may be presented with an image of the 485. Tap on that image and the user will be presented with an option to “View” 122. Select that option to open a full screen view of the 485 Plan PDF. You can use your finger to swipe up and down through different pages.
   Assessments/HAH Summaries (124)—View previously completed assessments or HAH Summaries.
   Schedule Summaries (126)—View previously completed shift task summaries.
Sign Out (71)—Initiates the sign out process.
Medications (72)—is the report that serves as a legal record of the drugs administered to a patient at a facility by a health care professional and is analog to the tasks tab but specifically for medications. Medications shown here are scheduled at the specified times in the task tab if the user is a nurse, or simply displayed here if the user is an HAH. Medications is a part of a patient's permanent record on their medical chart. The health care professional signs off on the record at the time that the drug or device is administered. Medications 72 includes the list of medications that the client takes and their schedules Skilled Nursing Staff can also use the Medications 72 tab to indicate that a PRN (pro re nata—when necessary) medicine has been given.
Assessments (74)—This tab is organized into sub-tabs based on the assessment section. Some tabs are restricted. HHAs may view and update the Vitals, Intake/Output, Pain and Narrative sections.
Supplies (76)—This tab displays the inventory list for the client. Use the supplies tab 76 to update quantities on hand, or to see if an item is on order.
Incidents (78)—Use this tab to record an incident.
Contacts (82)—Use this tab to look up important client contacts.
Previous (86)—This tab displays information related to the previous shift completed by the caregiver or another employee. It is appreciated that in some embodiments of the present invention, this tab is integrated into the Tasks tab via a filter to allow display of completed tasks for the past 48 hours.
Notes (90)—Notes added by the Clinical Staff, CC, or CSM will be included here Or synonymously referred to herein as case notes.

Continuing with the dashboard 60, the clock icon 62 leads to list of prior timesheets limited to the only patient. The run sync icon 80 initiates the syncing process, and the info icon 88 is used to access on line help. The run sync icon is optionally used for caregiver initiated synching and for system troubleshooting. The sign out icon 84 initiates the closing of a session or shift. During sign out several actions are carried out by the AP software automatically including:

Check for Incomplete Tasks—All tasks scheduled for the caregiver's shift must either be marked Completed or Deferred. The sign out procedures will not be able to continue if there are incomplete tasks remaining.

Check for Open Assessments/HAH Summaries—If the caregiver has an “In Process” assessment, the sign out process will not be able to continue. Complete the assessment as needed, then mark it complete. It is appreciated that in some embodiments of the present invention, this will close automatically.

Timesheets Confirmation—If all tasks and assessments are completed, the caregiver will be presented with the Timesheets Confirmation screen (see FIGS. 5R and 5S). The caregiver will then complete goals and sign. The caregiver must also review the shift activity with the client and have them sign. If the client is unable to sign, you may indicate that as well.

Close Timesheets—In the background, the timesheets will be closed automatically.

Sync—The application will exchange information with the server automatically to send back any changes made during your shift. This includes the timesheets.

The task tab 64 is selected in FIGS. 5A, 5B, 5C, 5D, and 5E, and the tasks that are to be completed during a shift are presented in 1 of 5 categories: Overdue 92, Due Now 94, Active PRN (As needed) 96, Upcoming 98, and completed today 100, attempted, and deferred. Selection of buttons 102 is used to update the status of a task to completed, attempted, and deferred. Attempted—the caregiver tried to complete the task but for some reason were unable to do so. The user selects a reason from the drop down menu in pop up overlay screen 110 (FIG. 5D). If the attempted option is selected, a record will be maintained of the attempt, but the task will continue to appear in the dashboard so that the task can be attempted again later. When a task is selected as completed, the task is moved to the completed section 100 of the dashboard. The selection of the deferred option means that the caregiver was unable to complete the task during their shift. This may occur after several attempts, or it may not be achievable during the caregiver's shift for other reasons. A reason for choosing the deferred option is found from the drop down menu in pop up overlay screen 110. If the deferred option is selected, the task will be moved to the completed section of the dashboard.

Tasks are typically created with a start and finish time. The dashboard 60 is organized into several task categories based on the task start and finish times. It is noted that if a task is marked “Priority”, the marked task will move to the top of the list and appear in red text. These priority marked tasks should always be considered first.

Tasks are categorized as follows:
Overdue (92)—If the current time is past the task planned finish time, the task will appear in this list. These tasks should be addressed immediately. The caregiver will receive periodic alerts if there are overdue tasks.
Due Now (94)—If the current time is between the task planned start and finish times, the task will appear in this list. The task should be completed first, unless there are overdue tasks. Periodic alerts are issued if there are tasks due.
Active (96)—If a task does not have a set time and can be completed as required (e.g., PRN), the task will appear in this list.
Upcoming (98)—If the current time is before the task planned start time, the task will appear in this list.
Completed Today (100)—Completed, Deferred and task Attempts will appear in this list so that may be referenced during a shift. It is appreciated that in some embodiments of the present invention, these tasks are combined into a single list.

These lists are organized into two screens. The caregiver navigates between the screens by swiping left or right with two fingers for the pad™, and may also press on the two dots at the bottom of the screen to switch between screens. It is appreciated that in some embodiments of these lists are integrated into a single screen.

As shown in FIG. 51 for screen shot 60B the activity tab 66 allows the caregiver to add a task that is not captured in the daily shift schedule, with a written description in comment/reason field 128. Tapping the “[+] Add” button 129 and selecting a standard task from the available list. A free form task (e.g., a task not in the standard list) by selecting “Other” from the list and entering the new task name. “Other” may be found at the bottom of the task list.

As shown in FIG. 5N and 50 incidents may be reported from dashboard display 60E or 60E′ with the selection of incident tab 150 and the following pull down menus:
Incident Date (151)—Tap on the field to open a calendar pop up.
Time (153)—Tap on the field to enter a time.
Category (154)—Choose one of the four categories presented (Fall, Injury, Medication Error, Other). This selection will be used to populate the options for Sub Category.
Sub Category (156)—Choose a sub category. The options available in the drop down menu will depend on the choice made for Category.
Description (158)—Add a brief summary of the incident.
Reported—Note if the incident has already been reported to the office.

Additional details may be added by tapping on the “+” icon 152, which open a pop up screen 159 as shown in FIG. 5P and FIG. 5Q, where the caregiver can enter more information. Tap the “+” icon 152 again to close the pop up. In operation, in particular inventive embodiments, when a minimum of information is recorded an email is automatically sent to the office staff without waiting for a sync event.

As shown in FIG. 5K and FIG. 5L the amount of supplies may be updated with selection of the supplies tab 140 and click on the quantity 142 for the item that needs updating. Supplies listed are specific to the client. If there is not enough of a particular supply, the Quantity Available will appear in red highlight (142). This happens when the Quantity Available is less than the Reorder Level. If the Units are mismatched, they will appear in yellow highlight.

The quantities on hand may be updated at any time by tapping on the “Update” button 143 to bring up overlay 60D-1 in FIG. 5M called “Inventory Check-In” 144 and entry in the new quantity 146 or update the units 148. Tap the “OK” button 149 to finish. The program will automatically capture a task to reflect that the caregiver has updated the inventory list.

The timesheets review screen 60H as shown in FIG. 5U may be accessed by selecting the clock icon 62. The timesheets review screen 60H allows the caregiver to review their past timesheets. In order to review the shift summary, the caregiver taps on the “Rpt” button 192 on the timesheets row. If the “Sign” button 190 appears in red text (or other colored text) that means that one or both signatures is absent. Tap the red sign button 190 to add missing signatures.in overlay 194 shown in FIG. 5W. If the “Draft” checkbox 191 is checked, this means that the care management organization closed the user timesheets for a previous shift. The user should review with the office to confirm their shift times. The user can uncheck the checkbox.

During the sign out process, the caregiver is presented with the Timesheets Confirmation screen 60G-1 and 60G-2 of FIG. 5R and FIG. 5S, respectively. To sign, tap the “Caregiver Signature” box 174. A signature screen will appear. Sign with your finger and click “Accept” to confirm, or “Clear” to try again. This is readily accomplished with conventional software. The client signs using the same method in box 176. If the client is unavailable to sign, check the option at the bottom of the screen labeled “Client Unable to Sign” 178. Clicking the shift goals button 170 brings up overlay 180 in FIG. 5U, which has a series of Yes and No question about the care of the client.

FIG. 5J shows the assessment screen 60C with the assessment tab 74 selected. Condition tabs 130 categorize patient conditions, such as pain 132 which is selected in the example. FIG. 5R is a contact list with the contacts tab 160 selected.

FIG. 5X is a download screen 601 with link 200, and FIG. 5Y shows that the download has occurred, and selecting the download icon 202 completes the loading of the software. This is readily accomplished with conventional software.

Embodiments of the inventive home health care management and performance platform have a GUI designed for use on personal computers (PC) in the home health care office for adding new clients and corresponding care plans and tasks that are assigned to caregivers in the field. In addition information collected by the caregivers at remote locations on their portable computing devices is received by the PC based program. The PC program organizes the gathered information and generates reports for medical and financial purposes. The PC's are connected to a server for storing the collected information in a database. Whereas field staff open a dashboard, office staff open a case list. As used herein, a PC is defined to include a desktop, a laptop, a tablet, or a smart phone, regardless of whether operating WINDOWS®, Linux, or MAC OS®.

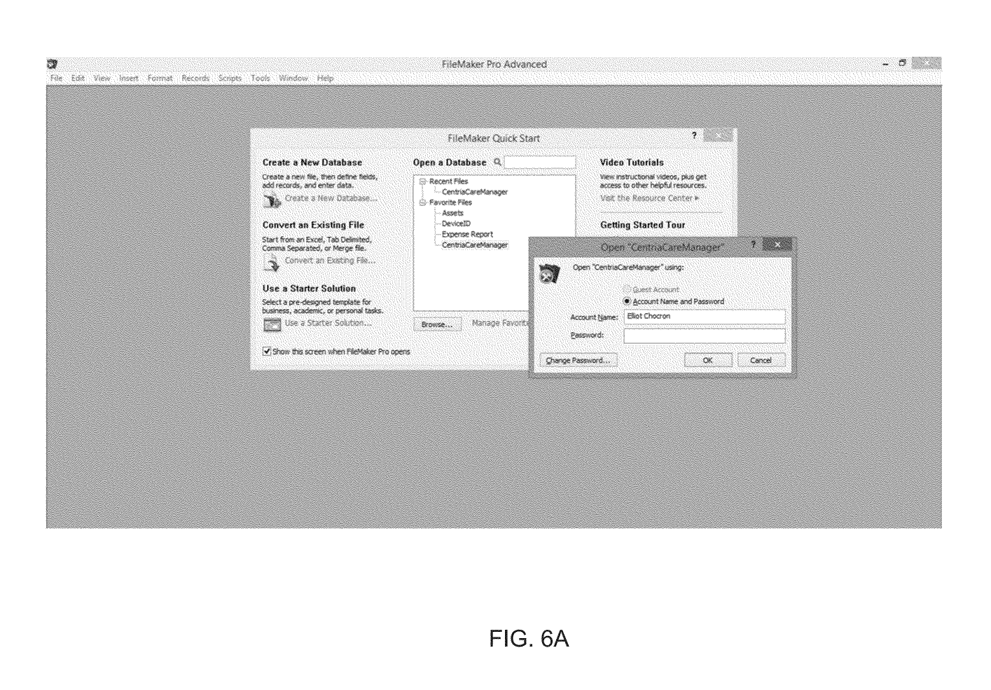

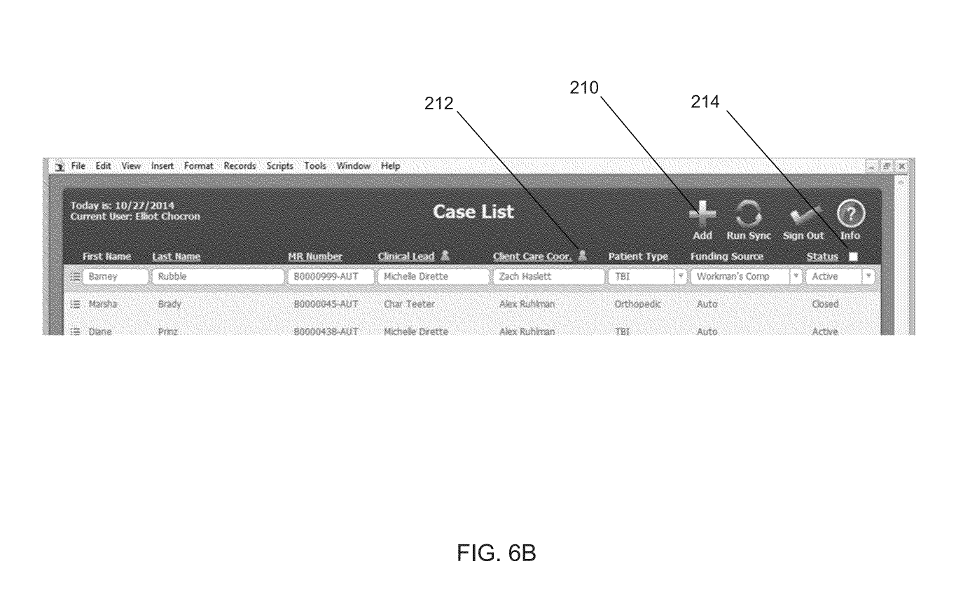

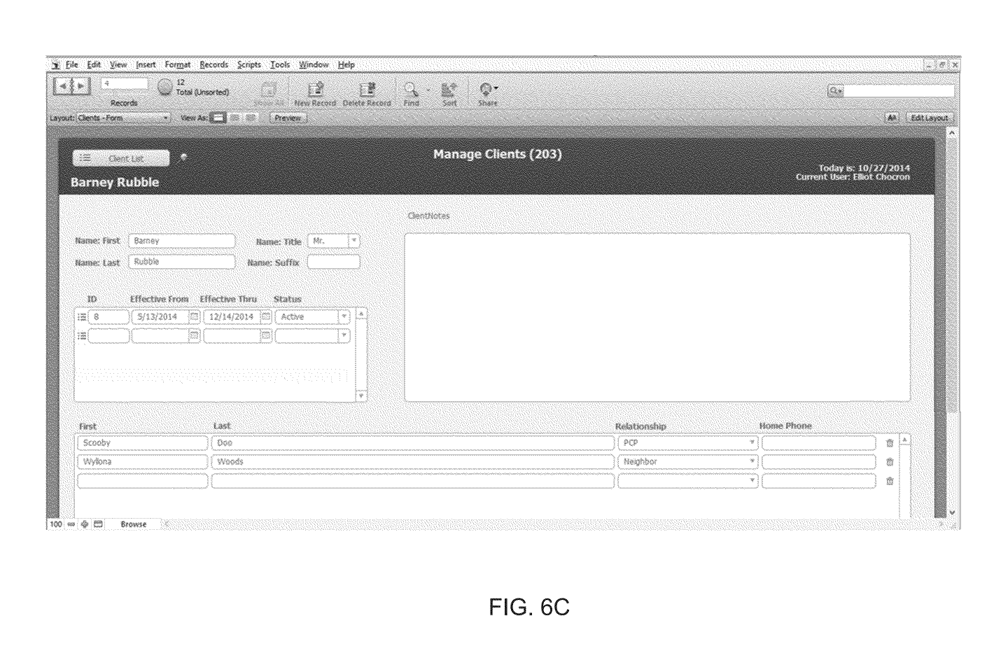

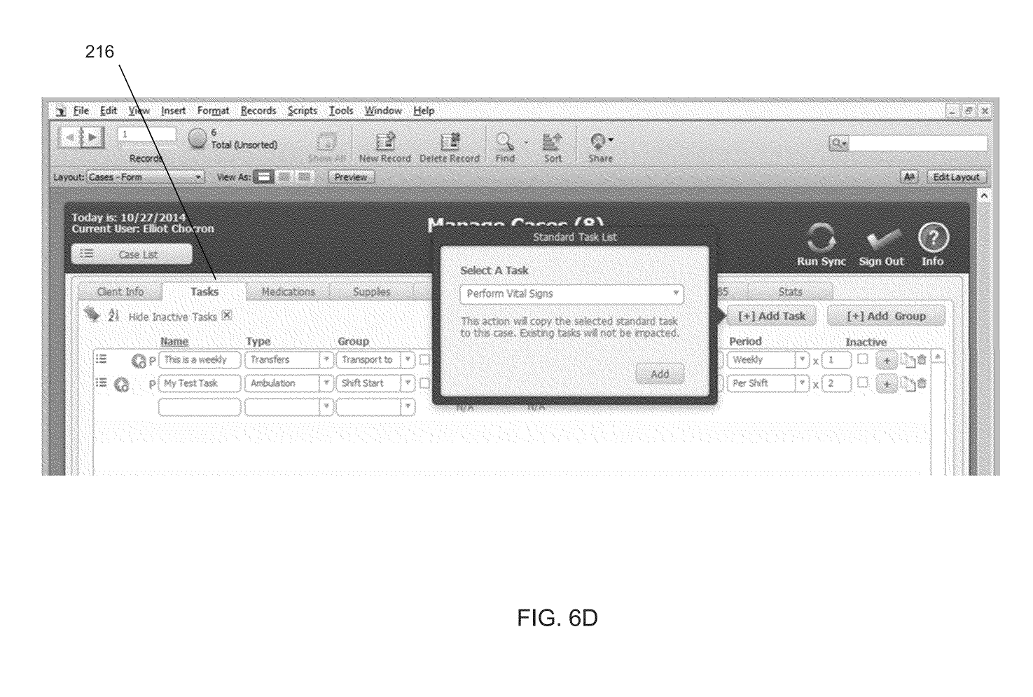

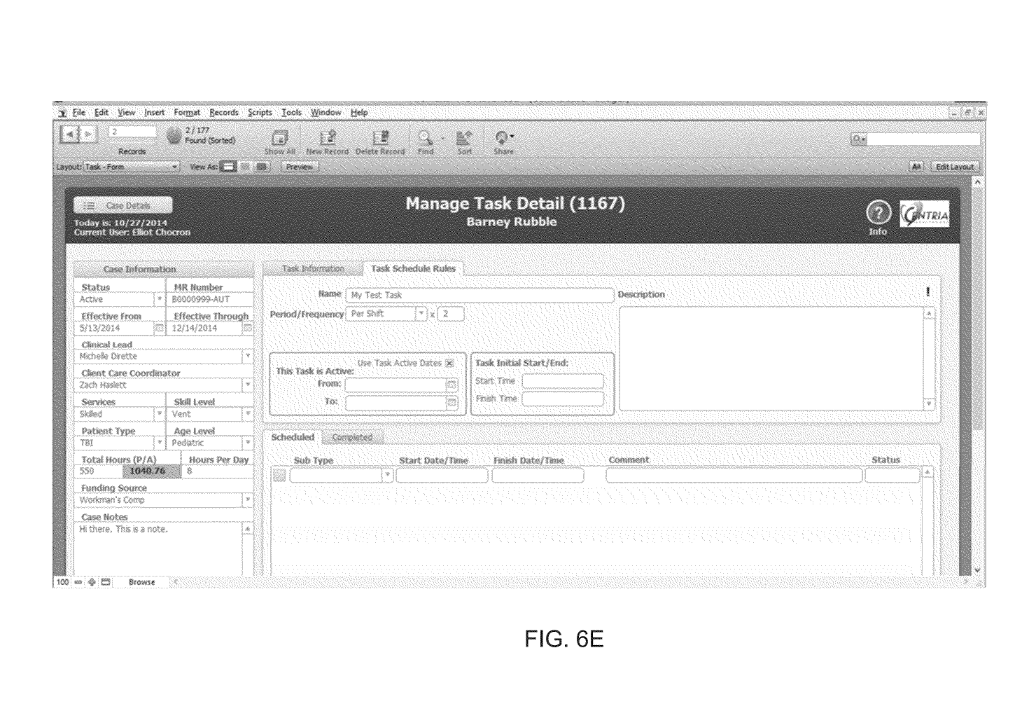

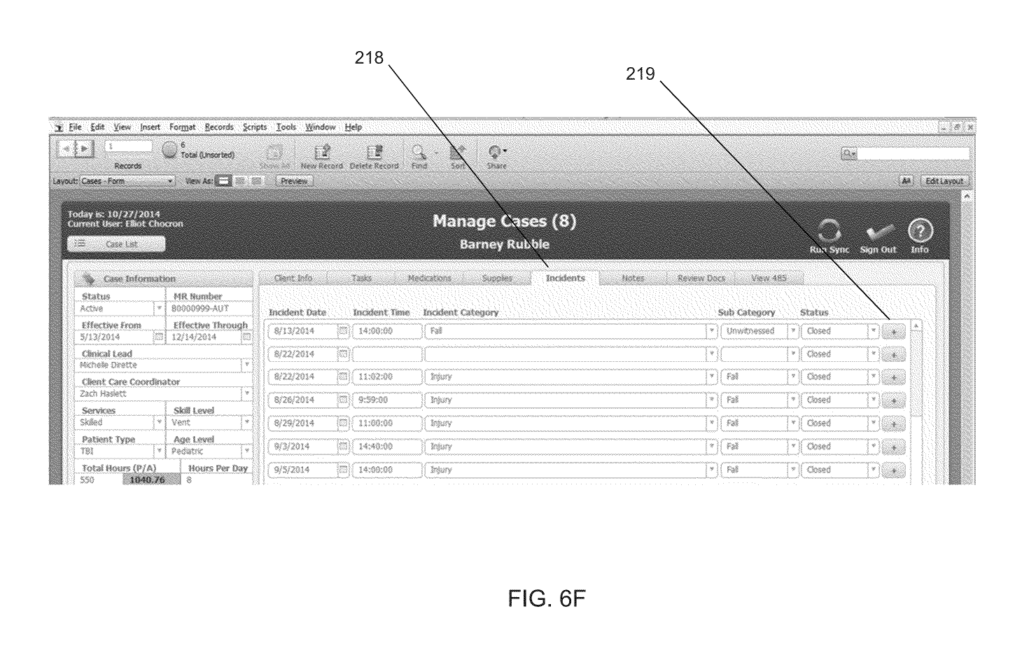

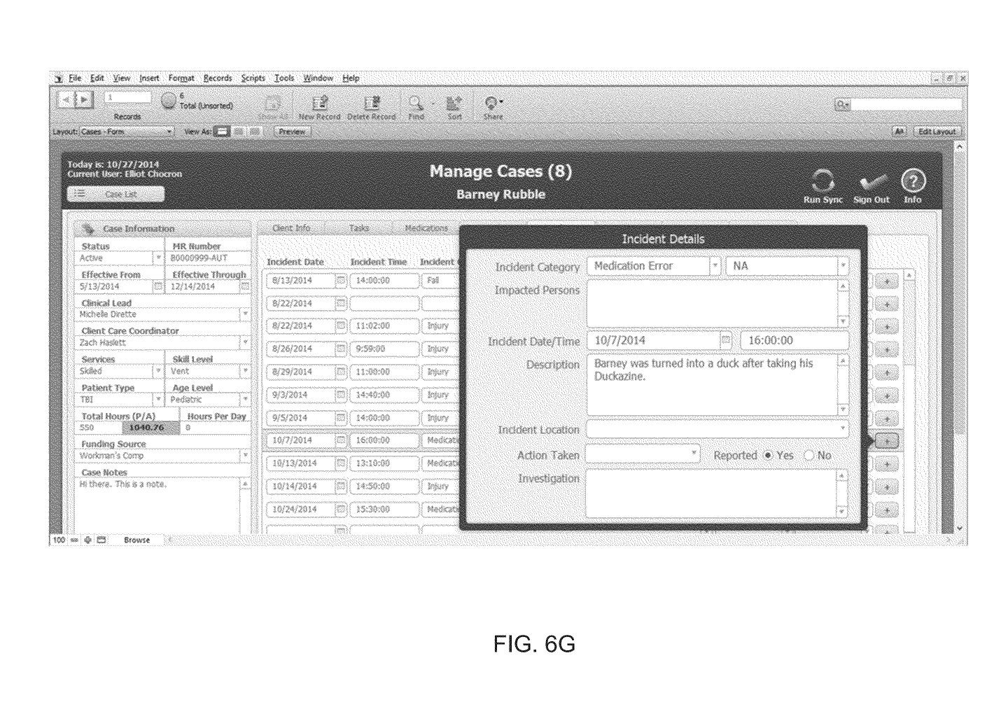

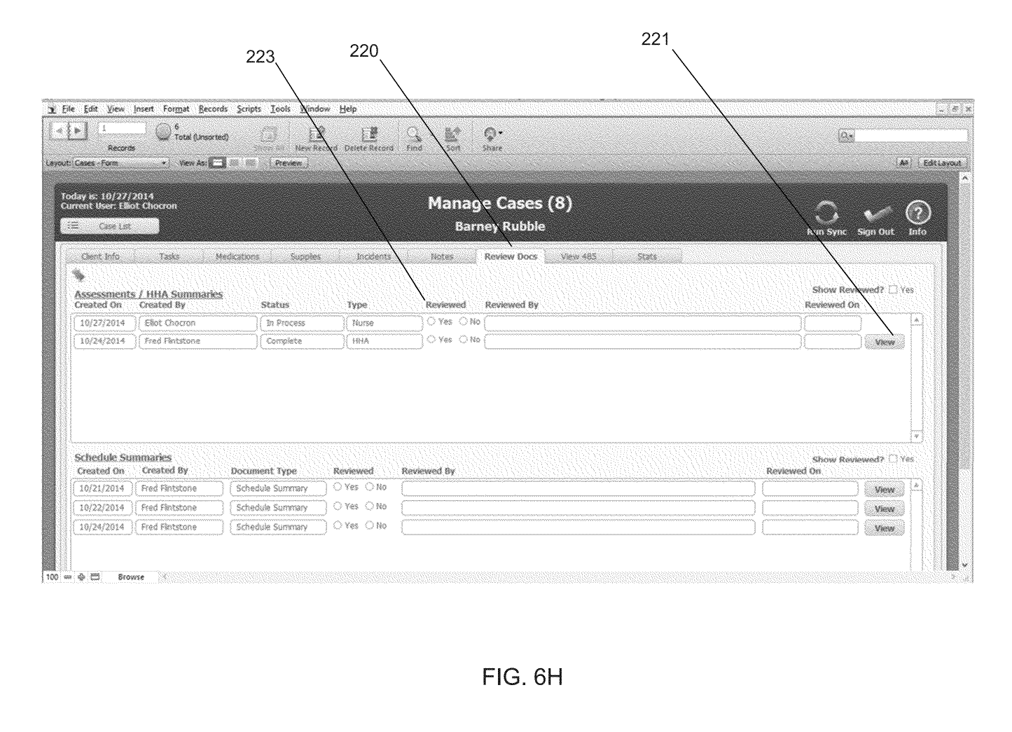

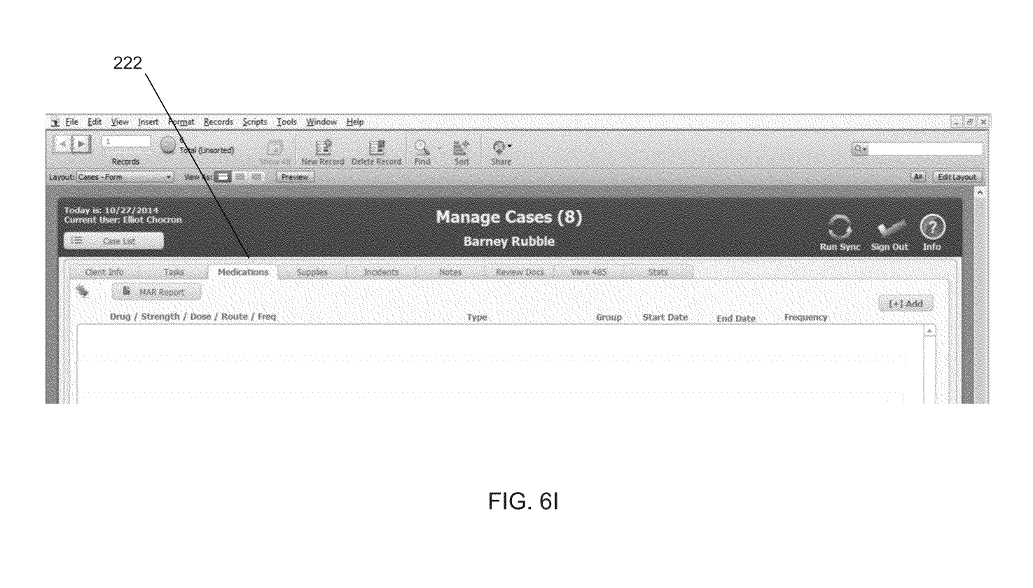

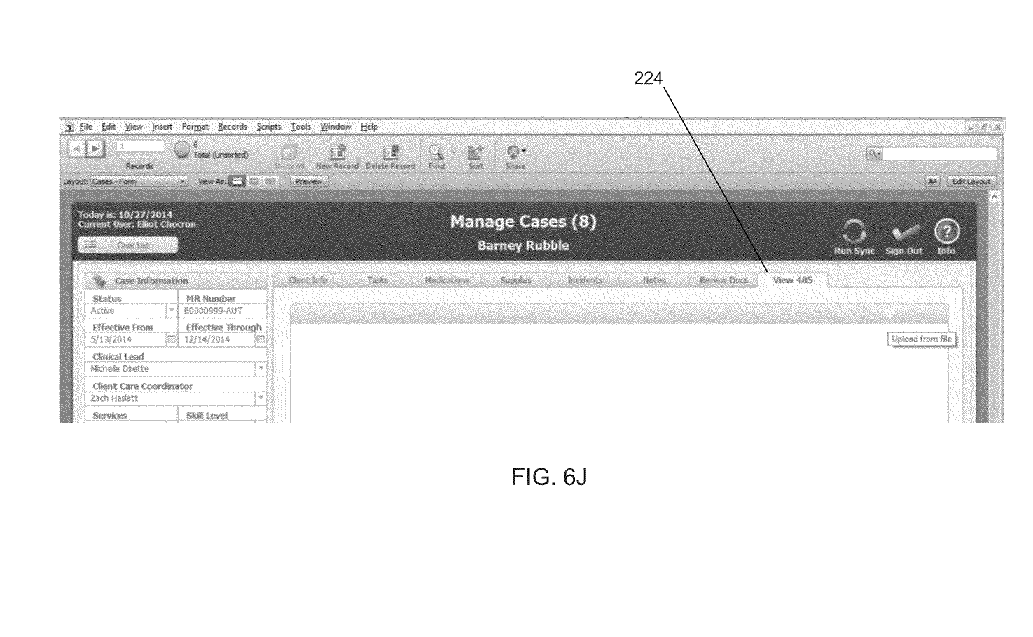

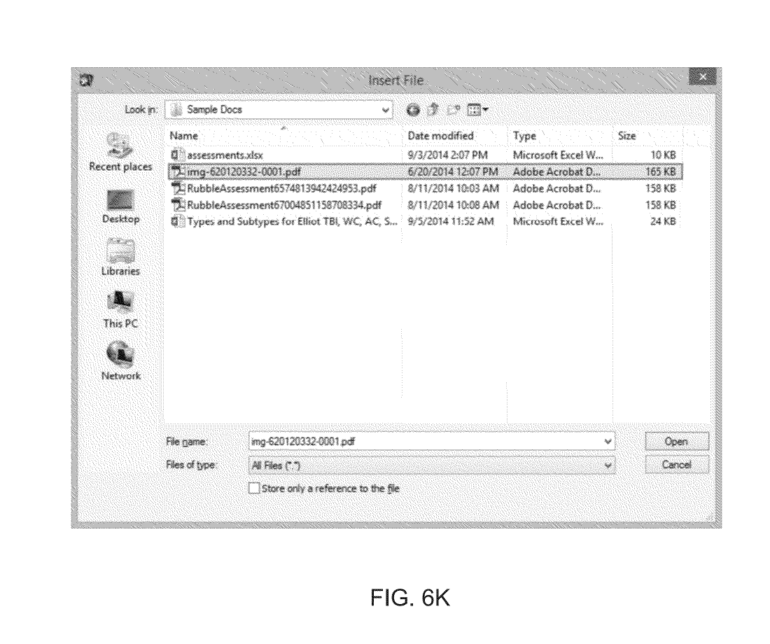

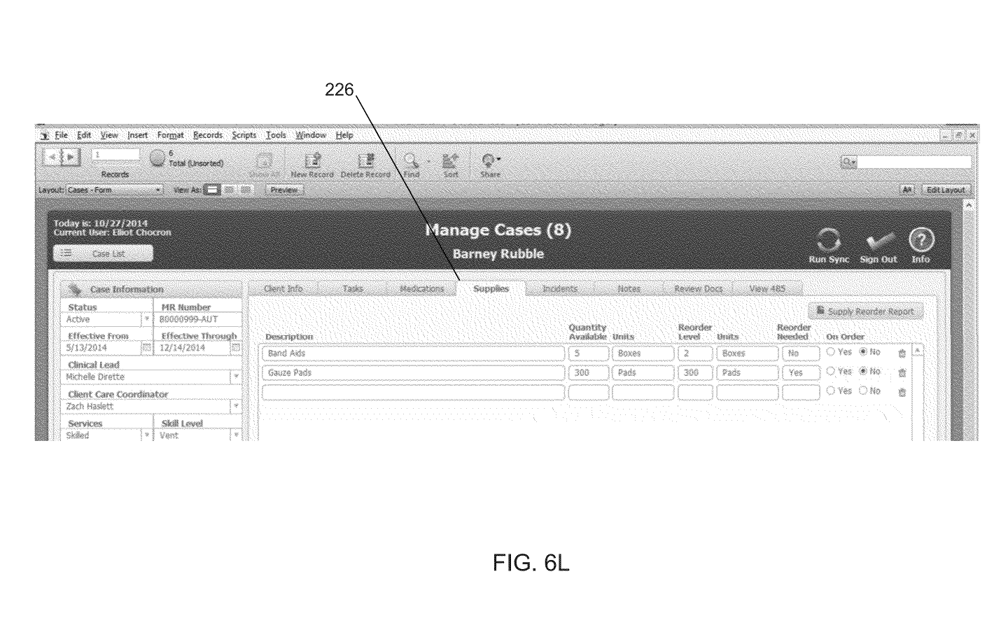

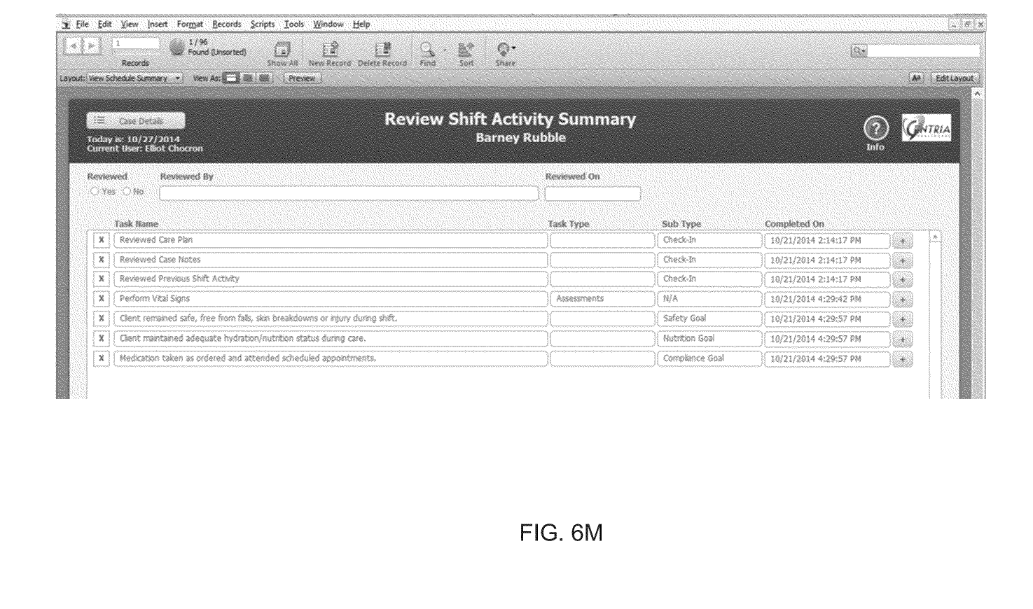

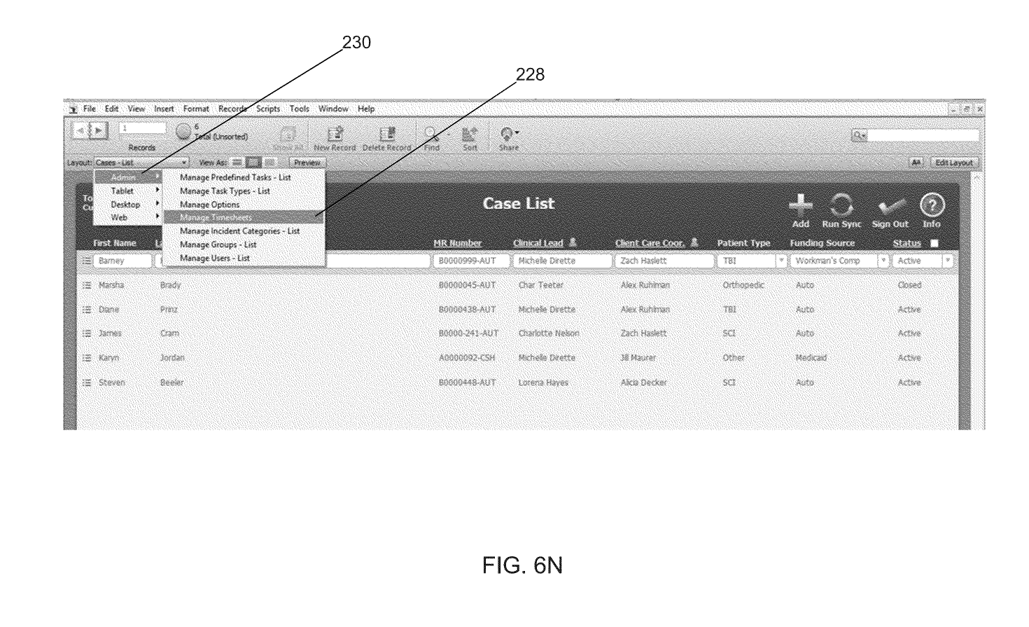

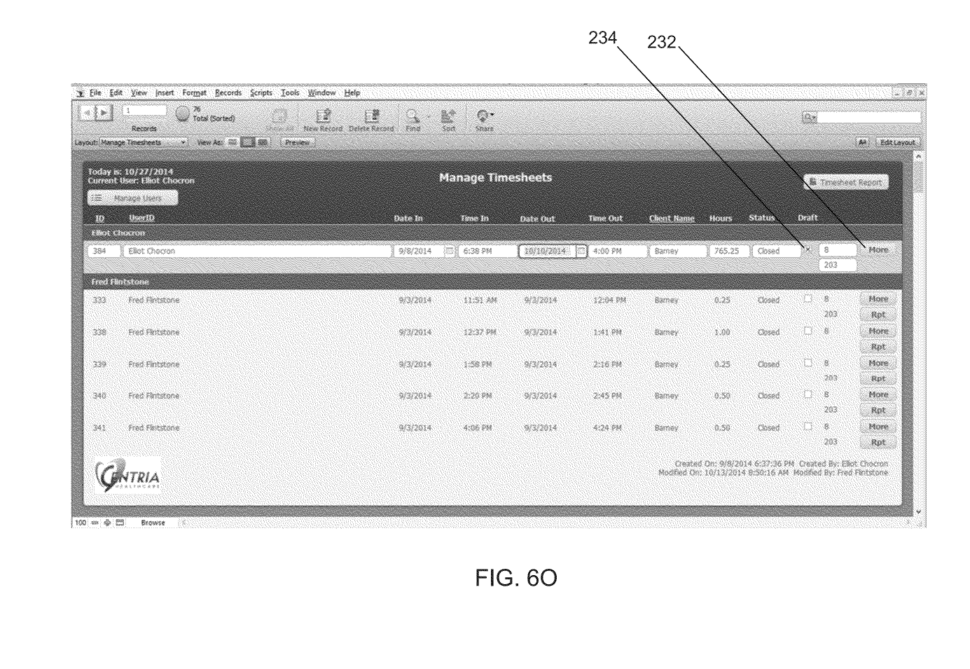

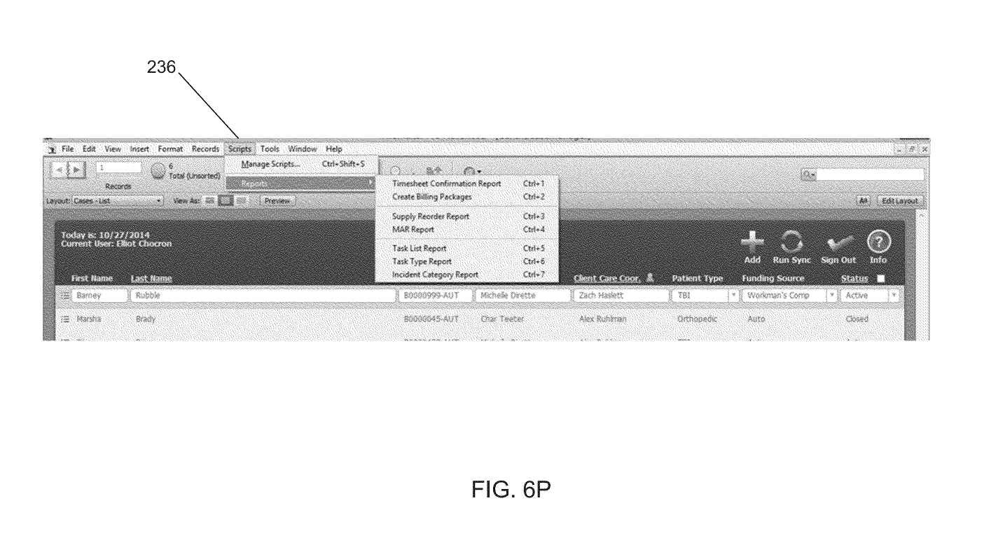

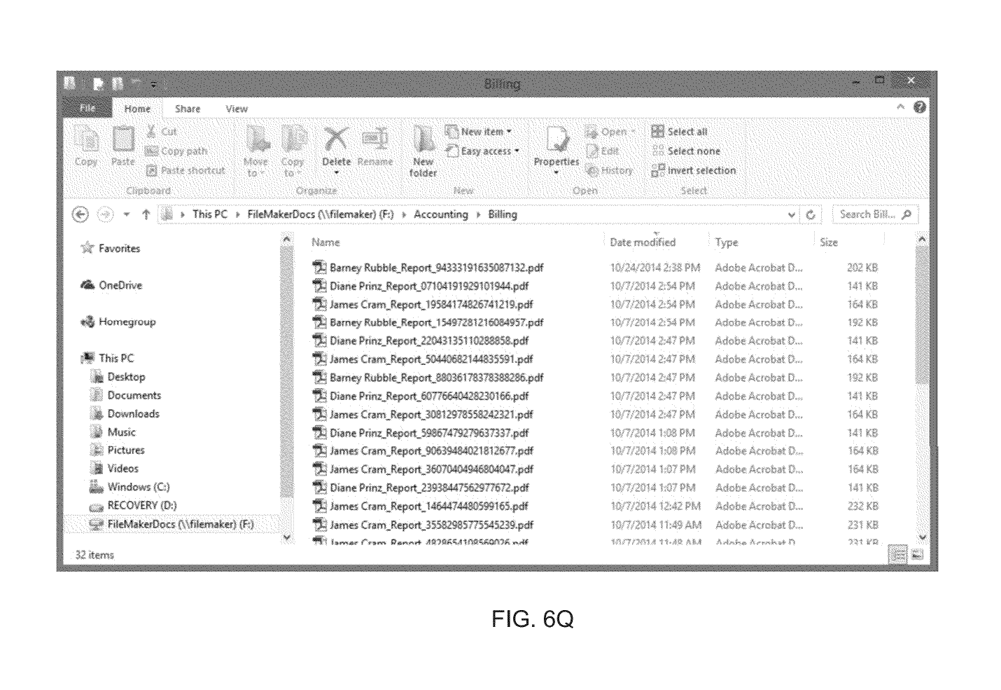

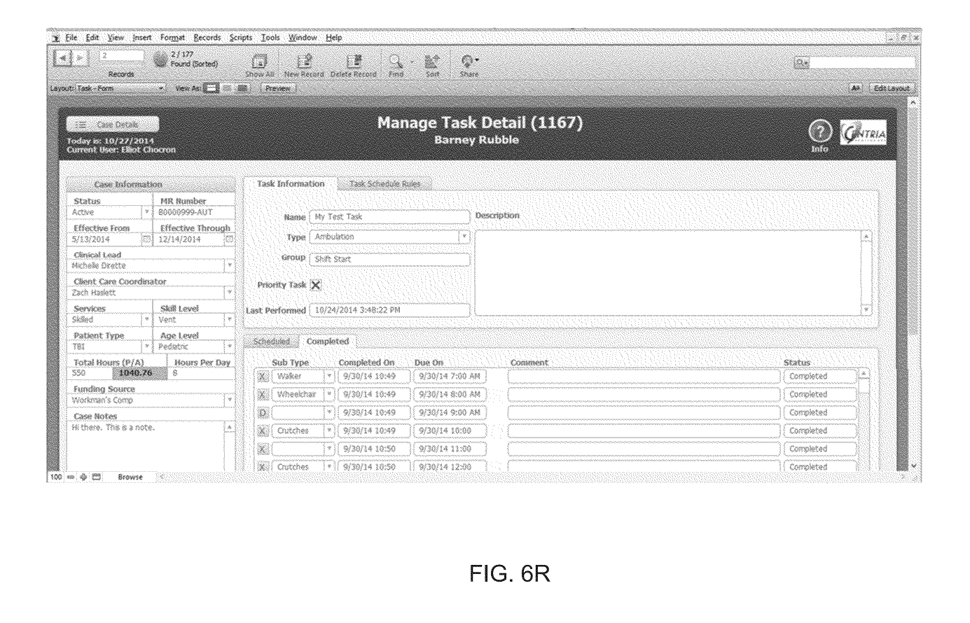

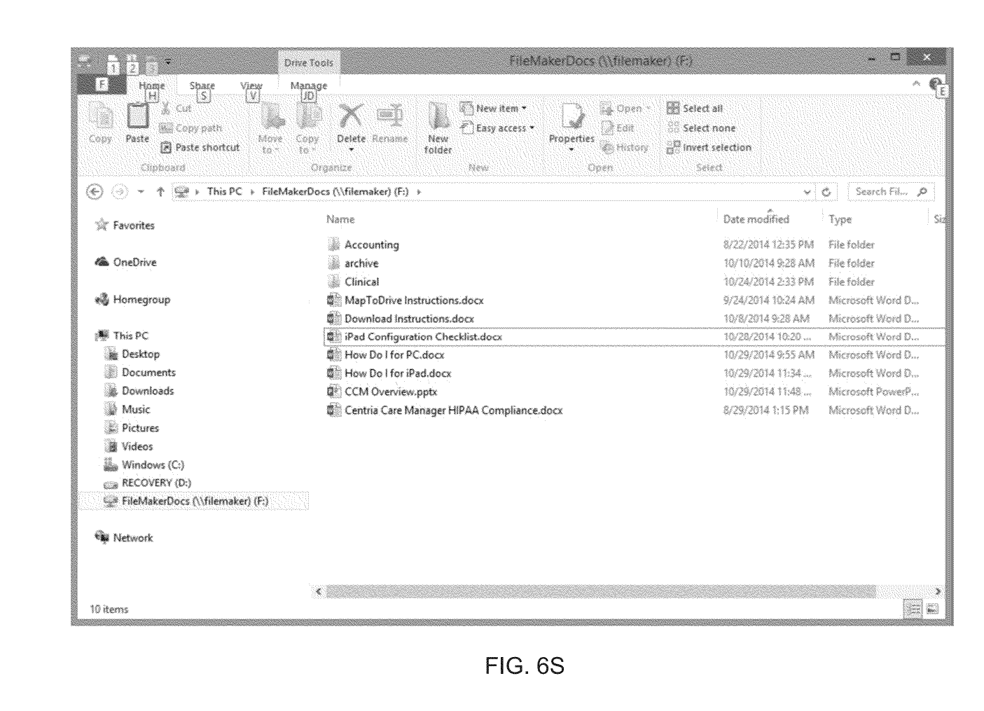

FIGS. 6A, 6B, 6C, 6D, 6E, 6F, 6G, 6H, 61, 6J, 6K, 6L, 6M, 6N, 6O, 6P, 6Q, 6R, and 6S are screen shots of a graphical user interface of the management and performance platform for home health caregivers on a personnel computer for use in the health care agency office in accordance to an embodiment of the invention. FIG. 6A is a screenshot of a login screen and start page. This is readily accomplished with conventional software, such as FileMaker Pro®. FIG. 6B is a case list view of home care clients. The add new case icon 210 is used to add new cases to the case list view, where the selection of the icon 210 adds a blank row to the case list for the entry of details related to the new patient/client. The find me icon 212 may be used to filter the cases to just those assigned to a specific user who is logged on to their account. Closed cases may be hidden from view in the list by checking the status box 214. FIGS. 6C and FIG. 6D is a client management page showing the addition of multiple cases to a client, or the assignment of multiple case workers to a client. It is noted that that a dedicated tablet such as an pad™ is not only limited to viewing a specific client case, but may only be used by one caregiver at a time. In a specific embodiment, if there are multiple caregivers in the home at different times, they may share the tablet if the caregivers are either all HHAs or all nurses. HHAs must always use the tablet assigned to HHAs and nurses must use the tablet assigned to nurses. If there are multiple people in the home at the same time, then each person must use different tablets assigned to each of them.

FIG. 6D shows a pop up overlay for adding a task selected via tab 216 on the manage cases page. In some inventive embodiments, users can add a single Standard Task (previously defined by office staff) or a Group of Standard Tasks (previously organized into a group by office staff, where FIG. 6E is a task detail screen. In a specific embodiment if a task is missing key information, the task may appear in a highlighted color, for example red. FIGS. 6F and 6G are pages related to task incidents (tab 218) on the manage cases page. Incidents are logged on the tablet. When the tablet user syncs, the data will be available to office staff. However, in order to avoid time lags for critical events, in a specific embodiment, limited incident details may be emailed to the office staff, once a minimum of details has been entered by the caregiver. This includes date and time, incident category, and description. Once an incident has been synchronized, office staff may review additional incident details and enter their own investigation comments. The use may click on the “+” button 219 on the incident row to view the details pop up as shown in FIG. 6G. Incidents may be closed once they have been addressed. Closed incidents will no longer be displayed on the tablet.

FIG. 6H is a document review page selected via review docs tab 220 on the manage cases page. As field staff complete shifts, the details will be available on the review docs tab 220 for clinical staff review. The review docs tab 220 includes two lists:
Assessments (Nursing Flow Sheets) and HAH Summaries
Schedule Summaries
   To review either of the lists, the user simply clicks on the “View” button 221 on the item row. If there is no button, then no details are available to review. Once the user has reviewed the item, the user checks the review button 223 to indicate they have reviewed the item. This action will capture the user name and timestamp the record. A PDF report will then be generated and saved to the server.

FIG. 6I is a screen shot for managing medications for a patient/client selected via tab 222 on the manage cases page. Medicines function similarly to tasks, where medicines may be added or deleted and the medicines generate schedule events on the tablets for administration. However, in specific embodiments there may be the following differences:
1. Medicines are viewable on the tablets for only some roles.
2. Schedule events will not be generated for home health aides (HAH) on the tablets.
3. Medicine names are entered using the following format “Drug/Strength/Dose/Route/Frequency”
4. Frequency periods available for medicines are more limited.
5. Daily medicines have an option to be given at specified times (multiple per day)
6. PRN medicines do not appear on the PRN Task on the tablet dashboard. Instead, PRN medicines appear on the Medications tab on the user tablet.

As shown in FIG. 6J, the view 485 tab 224 may be used to upload a 485 PDF file to the case. To do so, click on the “View 485” tab 224 and click the upload icon 226. Browse to a specific file and select the file to upload as shown in FIG. 6K. The file should be viewable in place. Supplies are added on the supplies tab 226 on the manage cases page of FIG. 6L. In an embodiment, a user enters in a description and a reorder level. The reorder level will be compared to the quantity on hand. If the quantity is less than the reorder level, the item will be marked as “Yes” in the “Reorder Needed” column and these items will also appear on the supply reorder report.

FIG. 6M is a shift activity summary. FIG. 6N is a screen for the manage timesheets menu option 228 in the admin menu 230. FIG. 6O is a manage timesheets page. The timesheets list may be sorted by ID, user ID (employee name), or client name. The user may locate the timesheets record they wish to revise and modify the editable fields. It is noted that changes should be documented in a comments field. By clicking the “More” button 232 to access the comments field. Items marked “Draft” 234 need to be confirmed. These are timesheets that have been forced closed and the end date/time may not be correct. The user should uncheck the draft checkbox 234 once the times have been updated.

FIG. 6P is a report menu. Reports are accessible from the scripts menu. In addition, some reports are available in specific tabs, as relevant. Non-limiting examples of reports include: Timesheets Confirmation Report—This report is intended for billing and payroll departments but it may be run by any user with access.
Billing Packages—This report is intended for billing and payroll. The billing packages report may be run for a specified time period (e.g., a week, consistent with the billing cycle). The report will cycle through all active cases (those marked pending or closed are excluded) and generate separate billing package PDFs for each case on the server. It is noted that billing and payroll should process all files on the server before rerunning the report. The screen shot shown in FIG. 6Q is a listing of billing packages available on a service providers computer server.
Supply Reorder Report—Lists all items requiring reorder across all cases.
MAR Report—Organized by client case. Lists all medication activity for a case.
In addition, there are three reports for use in managing admin functions such as task groups and lists.
   These include:
Task List Report—Listing of all standard tasks
Task Type Report—Listing of all Task Types and corresponding sub types
Incident Category Report—Listing of all Incident categories and corresponding sub categories.

In specific inventive embodiments reports may be saved to a file that may be saved to the database or saved to folder on the server. In general, since tablets don't have access to the server, the tablets will save files to the database. Reports generated on the desktop will be saved to the server.

FIG. 6R provides a task history. The screen shot shown in FIG. 6S is a report directory. Additional administrative functions that are readily preformed illustratively include: Manage Users, Manage Categories, Manage Task Types, Manage Groups, or a combination thereof.

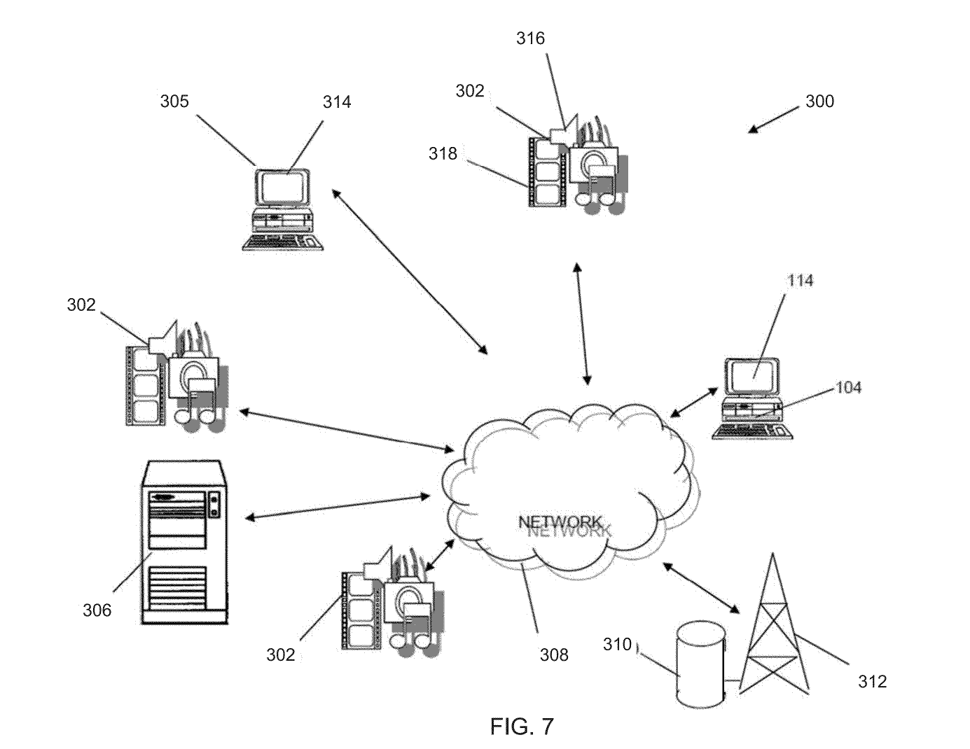

FIG. 7 is a schematic diagram illustrating an overall view of communication devices, computing devices, and mediums for implementing a system and method for the management and performance platform for home health caregivers.

The system 300 includes multimedia devices 302 and desktop computer devices 304 configured with display capabilities 314 and processors for executing instructions and commands. It is appreciated that a PC can constitute a system 300. The multimedia devices 302 are optionally mobile communication and entertainment devices, such as cellular phones, tablets, and mobile computing devices that in certain embodiments are wireless sly connected to a network 308. The multimedia devices 302 typically have video displays 318 and audio outputs 316. The multimedia devices 302 and desktop computer devices 304 are optionally configured with internal storage, software, and a graphical user interface (GUI) for carrying out elements of the home health care platform according to embodiments of the invention. The network 308 is optionally any type of known network including a fixed wire line network, cable and fiber optics, over the air broadcasts, satellite 320, local area network (LAN), wide area network (WAN), global network (e.g., Internet), intra net, etc. With data/Internet capabilities as represented by server 306. Communication aspects of the network are represented by cellular base station 310 and antenna 312. In a preferred embodiment, the network 308 is a LAN and each remote device 302 and desktop device 304 executes a user interface application (e.g., Web browser) to contact the server system 306 through the network 308. Alternatively, the remote devices 302 and 304 may be implemented using a device programmed primarily for accessing network 308 such as a remote client.

The software for the diagnostic platform, of embodiments of the invention, may be resident on tablets, 302 desktop or laptop computers 304, or stored within the server 306 or cellular base station 310 for download to an end user. Server 306 may implement a cloud-based service for implementing embodiments of the platform with a multi-tenant database for storage of separate client data for each independent home health care agency carried out on the platform.

The foregoing description is illustrative of particular embodiments of the invention, but is not meant to be a limitation upon the practice thereof. The following claims, including all equivalents thereof, are intended to define the scope of the invention

1. An automated method for assigning tasks and monitoring the performance of tasks by a caregiver, said method comprising:
providing a graphical user interface (GUI) on a remote computing device assigned to a patient location;
sending a care plan with a set of tasks to the remote computing device from a central computer, the set of tasks to be performed by the caregiver for the patient during a defined period of time;
receiving an opening time stamp in response to the caregiver logging on to the remote computing device;
the caregiver performing an individual task from the set of tasks on the patient;
receiving additional time stamps as the individual task from the set of tasks is performed and logged on the remote computing device;
receiving an assessment of patient condition in response to the caregiver inputting the assessment of patient condition into the remote computing device;
receiving a closing time stamp in response to the caregiver logging off the remote computing device; and
communicating at least the opening time stamp, the additional time stamps, and the closing time stamp to the central computer.

2. The method of claim 1 further comprising generating documentation from the received the opening time stamp, the additional time stamps, and the closing time stamp and optionally the assessment for timesheets, payroll, insurance billing, and medical record keeping.

3. The method of claim 1 further comprising real time monitoring for overdue tasks, incident reports, and inactivity at the patient location.

4. The method of claim 3 further comprising following up with the caregiver based on real time monitoring to ensure that the tasks are carried out.

5. The method of claim 1 further comprising remotely clearing or wiping data from the remote computing device, as well as load or restrict apes.

6. The method of claim 1 further comprising identifying the location of the remote computing device based on global positioning satellite (GPS) or an Internet protocol (TIP) address.

7. The method of claim 1 wherein communications between the remote computing device and the central computer are encrypted.

8. The method of claim 1 further comprising syncing the remote computing device to the central computer during log in.

9. The method of claim 1 further comprising generating an alert on the remote computing device with respect to the status of the tasks.

10. The method of claim 1 wherein the remote computing device is a mobile device.

11. The method of claim 1 further comprising modifying the care plan based on the assessment of patient condition.

12. The method of claim 11 wherein the modifying is performed by supervising medical personnel.

13. A system for assigning tasks and monitoring the performance of tasks by a caregiver, said system comprising:
a server connected via a network to a central computer;
one or more remote computing devices located at patient locations, the central computer in communication with the one or more remote computing devices;
a memory system in electrical communication with said server containing a machine readable medium having stored thereon one or more sequences of instructions which, when executed by a processor, cause a method to be carried out, the method comprising:
providing a graphical user interface (GUI) to the remote computing devices;
sending a care plan with a set of tasks to the remote computing device from a central computer, the set of tasks to be performed by the caregiver for the patient during a defined period of time;
receiving an opening time stamp in response to the caregiver logging on to the remote computing device at the central computer;
the caregiver performing an individual task from the set of tasks on the patient;
receiving additional time stamps as the individual task from the set of tasks is performed and logged on the remote computing device;
receiving an assessment of the patient's condition in response to the caregiver inputting the assessment into the remote computing device;
receiving a closing time stamp in response to the caregiver logging off the remote computing device; and
communicating at least the opening time stamp, the additional time stamps, and the closing time stamp to the central computer.

14. The system of claim 13 further comprising documentation generated from the received time stamps and assessment for timesheets, payroll, insurance billing, and medical record keeping.

15. The system of claim 13 wherein communications between the remote computing device and the central computer are encrypted.

16. The system of claim 13 wherein the one or more remote computing devices are synced to the central computer during log in.

17. The system of claim 13 wherein the one or more remote computing devices are a tablet.
